(19) United States
(12) Patent Application Publication
(10) Pub. No.: US 2023/0300655 A1
(43) Pub. Date: Sep. 21, 2023

(54) Method and Apparatus for Performing Measurement Associated to Resource

(71) Applicant: Telefonaktiebolaget LM Ericsson (publ), Stockholm (SE)

(72) Inventors: Santhan Thangarasa, Vällingby (SE); Ritesh Shreevastav, Upplands Väsby (SE); Muhammad Ali Kazmi, Sundbyberg (SE); Kazuyoshi Uesaka, Kawasaki, Kanagawa (JP); Jie Chen, Beijing (CN); Liping Zhang, Beijing (CN); Emre Yavuz, Stockholm (SE)

(21) Appl. No.: 18/019,341

(22) PCT Filed: Jul. 16, 2021
(86) PCT No.: PCT/CN2021/106812

§ 371 Date: Feb. 2, 2023

(30) Foreign Application Priority Data
Aug. 6, 2020 (WO) PCT/CN2020/107504
Aug. 19, 2020 (WO) PCT/CN2020/110093

(51) Int. Cl. H04W 24/10; H04B 17/318

(52) U.S. Cl. CPC H04W 24/10; H04B 17/328

(57) ABSTRACT

Embodiments of the present disclosure provide methods and apparatus for performing a measurement associated to a resource. A method performed at a terminal device comprises determining (S101) whether a first condition or a second condition is met, based on a communication quality; and performing (S102) a measurement associated to a resource, when the first condition is met, or stopping (S103) the measurement associated to the resource, when the second condition is met. According to embodiments of the present disclosure, the measurement may be performed or stopped under a first condition or a second condition. The relevant time and power may be saved.

### TECHNICAL FIELD

The present disclosure relates generally to the technology of wireless communication, and in particular, to methods and apparatuses for performing a measurement associated to a resource.

### BACKGROUND

This section introduces aspects that may facilitate better understanding of the present disclosure. Accordingly, the statements of this section are to be read in this light and are not to be understood as admissions about what is in the prior art or what is not in the prior art.

In the wireless communication system, a terminal device already connected to the network (i.e. any network node, such as the base station) might suffer bad communication quality with the network. In such situation, the terminal device may initiate a cell change procedure, such as a reestablishment procedure, and select a neighbor cell (sometimes including the current serving cell) to access.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Under a bad communication quality, if the terminal device initiates a reestablishment procedure, the reestablishment procedure might be initiated after certain trigger, such as a radio link failure, RLF, and thus a latency may happen. Such procedure is time consuming and power consuming.

Certain aspects of the present disclosure and their embodiments may provide solutions to these or other challenges. There are, proposed herein, various embodiments which address one or more of the issues disclosed herein. Improved methods and apparatuses are provided for performing a measurement associated to a resource. Particularly, the measurement may be performed or stopped under a first condition or a second condition. The time and power may be saved.

A first aspect of the present disclosure provides a method performed at a terminal device, comprising: determining whether a first condition or a second condition is met, based on a communication quality; and performing a measurement associated to a resource, when the first condition is met, or stopping the measurement associated to the resource, when the second condition is met.

In embodiments of the present disclosure, the resource comprises: at least one carrier frequency; and/or at least one cell.

In embodiments of the present disclosure, the method further comprises: obtaining a configuration for assisting the terminal device to perform a measurement associated to a resource.

In embodiments of the present disclosure, the configuration comprises at least one of: at least one identifier of the at least one carrier frequency; at least one identifier of the at least one cell; and a type of the measurement.

In embodiments of the present disclosure, the configuration further comprises at least one of: a source cell reference signal received power, RSRP, threshold for initiating a reestablishment procedure; a source cell reference signal received quality, RSRQ, threshold for initiating a reestablishment procedure; a target cell RSRP threshold; a target cell RSRQ threshold; or system information of the at least one cell.

In embodiments of the present disclosure, the configuration comprises at least one parameter associated to the first condition; and the at least one parameter includes at least one of: an operation mode; a coverage level; and a network capacity.

In embodiments of the present disclosure, the configuration is received from a network node.

In embodiments of the present disclosure, the network node provides the serving cell for the terminal device.

In embodiments of the present disclosure, the configuration is determined based on a rule.

In embodiments of the present disclosure, the method further comprises: determining the communication quality of a serving cell for the terminal device. The communication quality of the serving cell is determined by measuring a reference signal including at least one of: a narrowband reference signal, NRS; a narrowband secondary synchronization signal, NSSS; and a narrowband physical broadcast channel, NPBCH.

In embodiments of the present disclosure, the first condition comprises that a first event is triggered.

In embodiments of the present disclosure, the first condition comprises that a first event is triggered and at least a first period has elapsed since a triggering of the first event.

In embodiments of the present disclosure, a first timer and/or a first counter is started upon the triggering of the first event; and the first period has elapsed when the first timer expires and/or when the first counter reaches a set value.

In embodiments of the present disclosure, the first event is trigged when the communication quality is equal to or lower than a first threshold; and the first threshold is equal to or higher than a value indicating that the terminal device is out of synchronization.

In embodiments of the present disclosure, the first event is cancelled when a second event is triggered.

In embodiments of the present disclosure, the second event is trigged when the communication quality is equal to or higher than a second threshold; and the second threshold is equal to or higher than a value indicating that the terminal device is in synchronization.

In embodiments of the present disclosure, the method further comprises: performing a cell change procedure, based on at least a result of the measurement; and the cell change procedure includes at least one of: a radio resource control, RRC, re-establishment; an RRC release with redirection; and a handover.

In embodiments of the present disclosure, the method further comprises: transmitting, to a network node, a first report about that the measurement is performed.

In embodiments of the present disclosure, the first report further comprises information about at least of: a cell, on which the measurement is performed; and a triggering condition for performing the measurement.

In embodiments of the present disclosure, the first report further comprises information about whether the terminal device is stationary or mobile.

In embodiments of the present disclosure, the terminal device stops an ongoing measurement being performed or to be performed, when a second condition is met.

In embodiments of the present disclosure, the second condition comprises that a second event is triggered.

In embodiments of the present disclosure, the second condition comprises that the second event is triggered and at least a second period has elapsed since the triggering of the second event.

In embodiments of the present disclosure, a second timer and/or a second counter is started upon the triggering of the second event; and the second period has elapsed when the second timer expires and/or when the second counter reaches a set value.

In embodiments of the present disclosure, the terminal device stops the ongoing measurement after an ongoing measurement activity is completed.

In embodiments of the present disclosure, the ongoing measurement activity comprises: a detection of a cell; or a layer 1 measurement.

In embodiments of the present disclosure, the method further comprises: transmitting, to a network node, a second report about that the ongoing measurement is stopped.

In embodiments of the present disclosure, the second report further comprises information about at least one of: a cell, to which the ongoing measurement is associated; and a triggering condition for stopping the ongoing measurement.

In embodiments of the present disclosure, the second report further comprises information about whether the terminal device is stationary or mobile.

In embodiments of the present disclosure, whether the terminal device is stationary or mobile is indicated by a communication pattern parameter.

In embodiments of the present disclosure, the measurement is performed if the terminal device is mobile, and a maximum repetition number, Rmax, of the terminal device is prolonged, if the terminal device is stationary.

In embodiments of the present disclosure, the terminal device comprises a narrow band internet of things, NB-IoT, device.

A second aspect of the present disclosure provides a method performed at a network node, comprising: transmitting, to a terminal device, a configuration for assisting the terminal device to perform a measurement associated to a resource.

In embodiments of the present disclosure, the resource comprises: at least one carrier frequency; and/or at least one cell.

In embodiments of the present disclosure, the configuration comprises at least one of: at least one identifier of the at least one carrier frequency; at least one identifier of the at least one cell; and a type of the measurement.

In embodiments of the present disclosure, the configuration further comprises at least one of: a source cell reference signal received power, RSRP, threshold for initiating a reestablishment procedure; a source cell reference signal received quality, RSRQ, threshold for initiating a reestablishment procedure; a target cell RSRP threshold; a target cell RSRQ threshold; or system information of the at least one cell.

In embodiments of the present disclosure, the configuration comprises at least one parameter associated to the first condition; and the at least one parameter includes at least one of: an operation mode; a coverage level; and a network capacity.

In embodiments of the present disclosure, the network node provides the serving cell for the terminal device.

In embodiments of the present disclosure, the configuration is determined based on a rule.

In embodiments of the present disclosure, the method further comprises: receiving, from the terminal device, a first report about that the measurement is performed.

In embodiments of the present disclosure, the first report further comprises information about at least of: a cell, on which the measurement is performed; and a triggering condition for performing the measurement.

In embodiments of the present disclosure, the first report further comprises information about whether the terminal device is stationary or mobile.

In embodiments of the present disclosure, the method further comprises: reducing scheduled resources for the terminal device, in response to receiving the first report; and/or transmitting, to another network node, a message indicating that the terminal device performs the measurement on a resource associated with the another network node, in response to receiving the first report.

In embodiments of the present disclosure, the method further comprises: receiving, from the terminal device, a second report about that an ongoing measurement is stopped.

In embodiments of the present disclosure, the second report further comprises information about at least one of: a cell, to which the ongoing measurement is associated; and a triggering condition for stopping the ongoing measurement.

In embodiments of the present disclosure, the second report further comprises information about whether the terminal device is stationary or mobile.

In embodiments of the present disclosure, the method further comprises: improving scheduled resources for the terminal device, in response to receiving the second report.

In embodiments of the present disclosure, whether the terminal device is stationary or mobile is indicated by a communication pattern parameter.

In embodiments of the present disclosure, the measurement is performed if the terminal device is mobile, and a maximum repetition number, Rmax, of the terminal device is prolonged, by the network node, if the terminal device is stationary.

In embodiments of the present disclosure, the network node comprises a base station; and/or the terminal device comprises a narrow band internet of things, NB-IoT, device.

A third aspect of the present disclosure provides a terminal device, comprising: a processor; and a memory, the memory containing instructions executable by the processor. The terminal device is operative to: determine whether a first condition or a second condition is met, based on a communication quality; and perform a measurement associated to the resource, when the first condition is met, or stop the measurement associated to the resource, when the second condition is met.

In embodiments of the present disclosure, the terminal device is further operative to perform the method according to any of embodiments described above.

A fourth aspect of the present disclosure provides a network node, comprising: a processor; and a memory, the memory containing instructions executable by the processor. The network node is operative to: transmit, to a terminal device, a configuration for assisting the terminal device to perform a measurement associated to a resource.

In embodiments of the present disclosure, the network node is further operative to perform the method according to any of embodiments described above.

A fifth aspect of the present disclosure provides a computer-readable storage medium storing instructions which when executed by at least one processor, cause the at least one processor to perform the method according to any one of embodiments described above.

A sixth aspect of the present disclosure provides a terminal device, comprising: a determination unit, configured to determine whether a first condition or a second condition is met, based on a communication quality; and a performance unit, configured to perform a measurement associated to the resource, when the first condition is met, or a stop unit, configured to stop the measurement associated to the resource, when the second condition is met.

In embodiments of the present disclosure, the terminal device is further operative to perform the method according to any of embodiments of the first aspect.

A seventh aspect of the present disclosure provides a first network node, comprising: a transmission unit, configured to transmit, to a terminal device, a configuration for assisting the terminal device to perform a measurement associated to a resource.

In embodiments of the present disclosure, the network node is further operative to perform the method according to any of embodiments of the second aspect.

Embodiments herein afford many advantages. For example, in embodiments herein, the measurement may be performed or stopped under a first condition or a second condition. The time and power may be saved. A person skilled in the art will recognize additional features and advantages upon reading the following detailed description.

### BRIEF DESCRIPTION OF DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 is an exemplary diagram showing a UE procedure for reporting DL channel quality report in MSG3.

FIG. 2 is an exemplary flow chart showing a method performed at a terminal device, according to embodiments of the present disclosure.

FIG. 3 is an exemplary flow chart showing a method performed at a network node, according to embodiments of the present disclosure.

FIG. 4A is an exemplary diagram showing a relation of out-of-synchronization (Qout) and in-synchronization (Qin);

FIG. 4B is an exemplary diagram further showing a relation of out-of-synchronization (Qout), in-synchronization (Qin), event1 (Q_{E1out}), and event2 (Q_{E2in}).

FIG. 5 is an examplary diagram showing an DCQR and AS RAI MAC control element.

FIG. 6 is an exemplary flow chart showing separate actions of network node for different type of terminal devices.

FIG. 7A is a block diagram showing exemplary apparatuses suitable for practicing the terminal device according to embodiments of the disclosure.

FIG. 7B is a block diagram showing exemplary apparatuses suitable for practicing the network node according to embodiments of the disclosure.

FIG. 8 is a block diagram showing an apparatus readable storage medium, according to embodiments of the present disclosure.

FIG. 9 is a schematic showing units for the terminal device, the network node, according to embodiments of the present disclosure.

FIG. 10 is a schematic showing a wireless network in accordance with some embodiments;

FIG. 11 is a schematic showing a user equipment in accordance with some embodiments;

FIG. 12 is a schematic showing a virtualization environment in accordance with some embodiments;

FIG. 13 is a schematic showing a telecommunication network connected via an intermediate network to a host computer in accordance with some embodiments;

FIG. 14 is a schematic showing a host computer communicating via a base station with a user equipment over a partially wireless connection in accordance with some embodiments;

FIG. 15 is a schematic showing methods implemented in a communication system including a host computer, a base station and a user equipment in accordance with some embodiments;

FIG. 16 is a schematic showing methods implemented in a communication system including a host computer, a base station and a user equipment in accordance with some embodiments;

FIG. 17 is a schematic showing methods implemented in a communication system including a host computer, a base station and a user equipment in accordance with some embodiments; and

FIG. 18 is a schematic showing methods implemented in a communication system including a host computer, a base station and a user equipment in accordance with some embodiments.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the term “network” or “communication network” refers to a network following any suitable wireless communication standards. For example, the wireless communication standards may comprise 5^{th} generation (5G), new radio (NR), 4^{th} generation (4G), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. In the following description, the terms “network” and “system” can be used interchangeably. Furthermore, the communications between two devices in the network may be performed according to any suitable communication protocols, including, but not limited to, the wireless communication protocols as defined by a standard organization such as 3rd generation partnership project (3GPP) or the wired communication protocols.

The term “network node” used herein refers to a network device or network entity or network function or any other devices (physical or virtual) in a communication network. For example, the network node in the network may include a base station (BS), an access point (AP), a multi-cell/multicast coordination entity (MCE), a server node/function (such as a service capability server/application server, SC S/AS, group communication service application server, GCS AS, application function, AF), an exposure node/function (such as a service capability exposure function, SCEF, network exposure function, NEF), a unified data management, UDM, a home subscriber server, HSS, a session management function, SMF, an access and mobility management function, AMF, a mobility management entity, MME, a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node may comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like.

Further, the term “network node” may also refer to any suitable function which can be implemented in a network entity (physical or virtual) of a communication network. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), etc. In other embodiments, the network function may comprise different types of NFs (such as PCRF (Policy and Charging Rules Function), etc.) for example depending on the specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VoIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP, such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and (or) B” should be understood to mean “only A, only B, or both A and B.” The phrase “A and/or B” should be understood to mean “only A, only B, or both A and B.”

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

A narrow band internet of things, NB-IoT, system will be illustrated as an exemplary circumstance for embodiments of the present disclosure, but it should be understood that embodiments of the present disclosure may also be applied to other systems, without limitation.

In Release 13, 3rd Generation Partnership Project (3GPP) developed Narrowband Internet of Things (NB-IoT). This new radio access technology provides connectivity to services and applications demanding qualities such as reliable indoor coverage and high capacity in combination with low system complexity and optimized power consumption.

In the following a set of exemplary aspects of the NB-IoT design is illustrated just for better understanding embodiments of the present disclosure.

To deliver a maximal deployment flexibility NB-IoT supports three basic mode of operations described as follows.

A stand-alone operation utilizes for example the spectrum currently being used by GSM/EDGE (Global System for Mobile Communication/Enhanced Data Rate for GSM Evolution) systems as a replacement of one or more GSM carriers. In principle it operates on any carrier frequency which is neither within the carrier of another system nor within the guard band of another system's operating carrier.

A guard band operation utilizes the unused resource blocks within an LTE carrier's guard-band. The term guard band may also interchangeably called as guard bandwidth.

An in-band operation utilizes resource blocks within a normal LTE carrier. The in-band operation may also interchangeably called as in-bandwidth operation.

The minimum system bandwidth in NB-IoT is 200 kHz. In this basic setup a NB-IoT anchor carrier is transmitted in the cell. It supports basic cellular functionality such as synchronization, broadcast of system information, data transmission, as well as paging and random access. The anchor carrier is also used by devices to perform idle mode measurements such as signal strength (narrow band reference signal received power, NRSRP) and signal quality (narrow band reference signal received quality, NRSRQ) measurements to support idle mode mobility.

To improve the system capacity NB-IoT can be configured as a multi-carrier system where the anchor carrier is complemented by a set of non-anchor carriers, each of 200 kHz. The non-anchor carriers support data transmission in RRC_CONNECTED from Release 13 but from Release 14 also paging and random access in RRC_IDLE. They, however, cannot be used for idle mode measurements, even though the device configured to perform random access and listen to paging on a non-anchor. To reduce the overhead from always-on signaling such as NRS (narrowband reference signal) it was agreed in 3GPP that UEs in RRC_IDLE shall perform measurements on the anchor carrier such that NRS can be omitted on non-anchors when not needed.

The purpose of a radio link monitoring (RLM) procedure is to monitor the radio link quality of the serving cell of the UE and use that information to decide whether the UE is in in-sync or out-of-sync with regard to that serving cell. In LTE, RLM is carried out by UE performing measurement on downlink reference symbols (cell-specific reference signal, CRS) in RRC_CONNECTED state. If results of radio link monitoring indicate number of consecutive out of sync (OOS) indications then the UE starts RLF procedure and declares radio link failure (RLF) after the expiry of RLF time (e.g. T310). The actual procedure is carried out by comparing the estimated downlink reference symbol measurements to some thresholds, Qout and Qin. Qout and Qin correspond to Block Error Rate (BLER) of hypothetical PDCCH/PCIFCH (physical downlink control channel/Physical Control Format Indicator Channel), ePDCCH (enhanced PDCCH) or MPDCCH (Machine Physical Downlink Control Channel) transmissions from the serving cell. Examples of the target BLER corresponding to Qout and Qin are 10% and 2% respectively. The radio link quality in RLM is performed based on CRS, at least once every radio frame (when not configured with Discontinuous Reception, DRX) or periodically with DRX cycle (when configured with DRX), over the full cell bandwidth which is also the control channel bandwidth (e.g. PDCCH and PCFICH) for LTE UE, or over the UE bandwidth for machine type communication, MTC UEs (e.g., Cat-M1, Cat-M2 UE).

Upon start of T310 timer or T313 timer as specified in clause 5.3.11 in TS 36.331 v14.4.0, the UE shall monitor the link of serving cell (e.g. Primary cell, PCell or Primary Secondary Cell, PSCell) for recovery using the evaluation period and Layer 1 indication interval corresponding to the non-DRX mode until the expiry or stop of T310 timer or T313 timer. The transmitter power of the UE shall be turned off within 40 ms after expiry of T310 timer and the transmitter power of PSCell if configured shall be turned off within 40 ms after expiry of T313 timer as specified in clause 5.3.11 in TS 36.331 V16.0.0. T310 is also called as RLF timer in that the RLF procedure starts upon triggering the RLF, which is triggered upon receiving N310 number of consecutive out-of-sync indications from its lower layers. When T310 expires then the RLF is declared. But T310 is reset upon receiving N311 number of consecutive in-sync indications from its lower layers. The network configured UE timers, T310 and T313, are specified in TS36.331 v16.1.1, which is incorporated herein by reference in its entirety, as follows:

| Timer | Start | Stop | At expiry |
|---|---|---|---|
| T310 | Upon detecting physical | Upon receiving N311 | If security is not activated: go to |
| NOTE1 | layer problems for the | consecutive in-sync indications | RRC_IDLE else: initiate the |
| NOTE2 | PCell i.e. upon receiving | from lower layers for the PCell, | connection re-establishment |
| | N310 consecutive out-of- | upon triggering the handover | procedure |
| | sync indications from | procedure and upon initiating | |
| | lower layers | the connection re-establishment | |
| | | procedure | |
| T311 | Upon initiating the RRC | Selection of a suitable E-UTRA | Enter RRC_IDLE |
| NOTE1 | connection re- | cell or a cell using another RAT. | |
| | establishment procedure | | |
| T313 | Upon detecting physical | Upon receiving N314 | Inform E-UTRAN about the |
| NOTE2 | layer problems for the | consecutive in-sync indications | SCG radio link failure by |
| | PSCell i.e. upon | from lower layers for the | initiating the SCG failure |
| | receiving N313 | PSCell, upon initiating the | information procedure as |
| | consecutive out-of-sync | connection re-establishment | specified in 5.6.13. |
| | indications from lower | procedure, upon SCG release | |
| | layers | and upon receiving | |
| | | RRCConnectionReconfiguration | |
| | | including | |
| | | MobilityControlInfoSCG | |

NOTE1:
Only the timers marked with “NOTE1” are applicable to NB-IoT.
NOTE2:
The behaviour as specified in 7.3.2 applies

The timers are configured by means of signaling e.g RRC signaling. The timers can have values: 0, 50 ms, 100 ms, 200 ms, 500 ms, 1000 ms and 2000 ms.

Upon expiry of RLF timer (e.g. T310) the UE initiates the radio resource control, RRC, connection re-establishment to a neighbour cell and starts another timer (T311). If T311 expires before the completion of the RRC connection re-establishment then the UE enters RRC idle state.

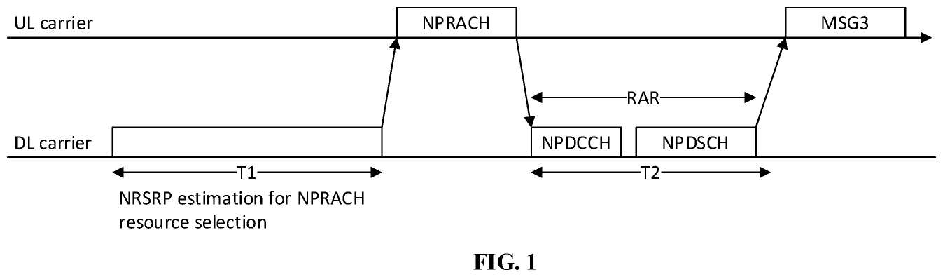

In Rel-14 3GPP introduced MSG3-based channel quality report functionality which consists of the quality measurement and reporting on MSG3. As illustrated in FIG. 1, in prior to the random access preamble transmission (MSG1), UE first estimates the coverage enhancement, CE level to decide which Physical Random Access Channel, NPRACH, resource is used for the preamble transmission (T1). If eNB can detect the preamble, eNB transmits the random access response (RAR (a.k.a. MSG2)), consisting of narrowband physical downlink control channel, NPDCCH and narrowband physical downlink shared channel, NPDSCH. After that UE transmits narrowband physical uplink shared channel, NPUSCH format 1 for RRC connection request (MSG3) where the NPUSCH transmission timing (k0) is specified by the eNB. UE supporting this downlink, DL, channel quality reporting will report an estimation of the number of repetitions required to decode NPDCCH with BLER of 1% in Msg3.

FIG. 1 is an exemplary diagram showing a UE procedure for reporting DL channel quality report in MSG3.

As shown in FIG. 1, the UE may firstly estimate NRSRP based on reference signal on the DL carrier during T1, and then select the narrowband physical random-access channel to transmit a message, such as a request for access. During T2, the receives information on NPDCCH and NPDSCH, from a network node and estimate a DL channel quality.

To report the channel quality, UE will report channel quality indicator-narrowband physical downlink control channel-narrowband, CQI-NPDCCH-NB and CQI-NPDCCH-Short-NB, depending on the RRC message. Table 1 and Table 2 show the reported value for each information element. When UE reports channel quality using CQI-NPDCCH-NB, UE can report the NPDCCH repetition level which achieve NPDCCH BLER of 1%. If UE need to report using CQI-NPDCCH-Short-NB, UE report the NPDCCH repetition level relative to the configured Rmax, maximum possible NPDCCH repetition level.

TABLE 1
Downlink channel quality measurement
report mapping of CQI-NPDCCH-NB

| Reported value | NPDCCH repetition level |
|---|---|
| noMeasurement | No measurement reporting |
| candidateRep-A | 1 |
| candidateRep-B | 2 |
| candidateRep-C | 4 |
| candidateRep-D | 8 |
| candidateRep-E | 16 |
| candidateRep-F | 32 |
| candidateRep-G | 64 |
| candidateRep-H | 128 |
| candidateRep-I | 256 |
| candidateRep-J | 512 |
| candidateRep-K | 1024 |
| candidateRep-L | 2048 |

TABLE 2
Downlink channel quality measurement
report mapping of CQI-NPDCCH-Short-NB

| Reported value | NPDCCH repetition level |
|---|---|
| noMeasurements | No measurement reporting |
| candidateRep-1 | Rₘₐₓ/8 (Note 1) |
| candidateRep-2 | Rₘₐₓ |
| candidateRep-3 | 4 × Rₘₐₓ (Note 2) |

Note 1:
When Rₘₐₓ is less than 8, set candidateRep-1 to 1.
Note 2:
When Rₘₐₓ is more than 512, set candidateRep-3 to 2048.

Network uses the reported repetition level to configure the RRC parameter “Rmax”, maximum possible repetition level, or later in connected mode to possibly trigger an RRC Reconfiguration procedure.

In 3GPP Rel-16 it is agreed to introduce the DL channel quality report in non-anchor carrier in IDLE mode. On top of that it was agreed to introduce the DL channel quality report in anchor/non-anchor carrier in CONNECTED mode. For the channel quality report in CONNECTED mode, MAC CE is used to trigger/report it, although the channel quality report in non-anchor in IDLE mode uses Msg3 as same as Rel-14.

In CONNECTED mode, UE performs radio link monitoring of the serving cell to evaluate the serving cell quality, and based on this evaluation UE declares radio link failure (RLF). For NB-IoT which can operate in normal and extended coverage, the RLM evaluation for out-of-sync can be quite long (e.g. 4000 ms in enhanced coverage), and after N310 consecutive out-of-sync indications are reached in the UE during the radio link failure timer, UE declares radio link failure (RLF) and turns off the transmitter. The UE then starts the RRC reestablishment timer T311 and attempts RRC establishment on same or different cell. The problem with this behavior is that, the NB-IoT UE is not required to identify any neighbor cell measurements nor performing any measurements on those in CONNECTED mode. Therefore, once the RLF is declared, it will take long time to find a suitable cell to make RRC reestablishment on, and during this time UE is not reachable to the NW.

In addition, neighbor cell measurements can be power consuming which is typically less of a problem for handheld device, but it may be an issue for an IoT device like NB-IoT which is supposed to operate with battery without charging. Therefore, any unnecessary or redundant measurements/transmissions should be avoided.

Further, the RLF may happen either when the UE is stationary or even when the UE is mobile (for mobile use case: city bikes fitted with NB-IoT device or for asset tracking etc.). Separate handling may be required based upon UE mobility status as reestablishment procedure may be required to perform on the same cell or different cell. Hence mechanism to identify and differentiate the handling would be required.

According to a first embodiment in a UE, which is preconfigured with information related to one or more neighbor cells for performing measurements, upon triggering at least one first type of event, initiates measurements on one or more neighbor cells based on the preconfigured information. The UE may also report that event to a network node e.g. to a serving network, NW e.g. a first NW (NW1). Initiating measurements herein comprising performing cell identification based on the synchronization signals (e.g. Narrowband Secondary Synchronization Signals, NSSS, narrowband physical broadcast channel, NPBCH) and/or performing signal measurements based on the reference signal (e.g. NRS, NSSS, NPBCH). In one example the first type of event, which triggers the UE to start the neighbor cell measurements is associated with a radio link monitoring procedure e.g. Event E1. In yet another example the UE starts a timer upon triggering of Event E1 and initiates the neighbor cell measurements upon the expiration of the timer.

According to a second embodiment, the UE, which is performing or configured to perform measurements on one or more neighbor cells, upon triggering at least one second type of event, suspends or stops or cancels the ongoing measurements on at least one cell. The UE may or may not have triggered start of the neighbor cell measurements based on event E1. The UE may also report that event to the NW node e.g. to NW1. An example of event, which triggers the UE to stop the ongoing neighbor cell measurements is associated with a radio link monitoring procedure e.g. Event E2 or RLM in-sync indication. In yet another example the UE starts a timer upon triggering of Event E2 or in-sync indication and stops or suspends the neighbor cell measurements upon the expiration of the timer.

The events E1 and E2 are also interchangeably called as earlyQout and earlyQin events respectively, or enhanced RLM events.

According to embodiments of the present disclosure, the UE can detect new cells faster and establish a connection to a new cell much faster after an RLF.

NW can know the UE's RLF in advance, and NW can take action such as reconfiguring the parameter or wait for the reestablishment.

NW can identify if UE is stationary or mobile and take actions based upon that.

The mechanism reduces UE power consumption, UE complexity and processing.

The mechanism prevents the UE to perform the measurements on neighbor cells on regular basis.

The time to perform cell change e.g. RRC re-establishment is reduced, compared to the case when the UE does not perform any measurement on neighbor cells.

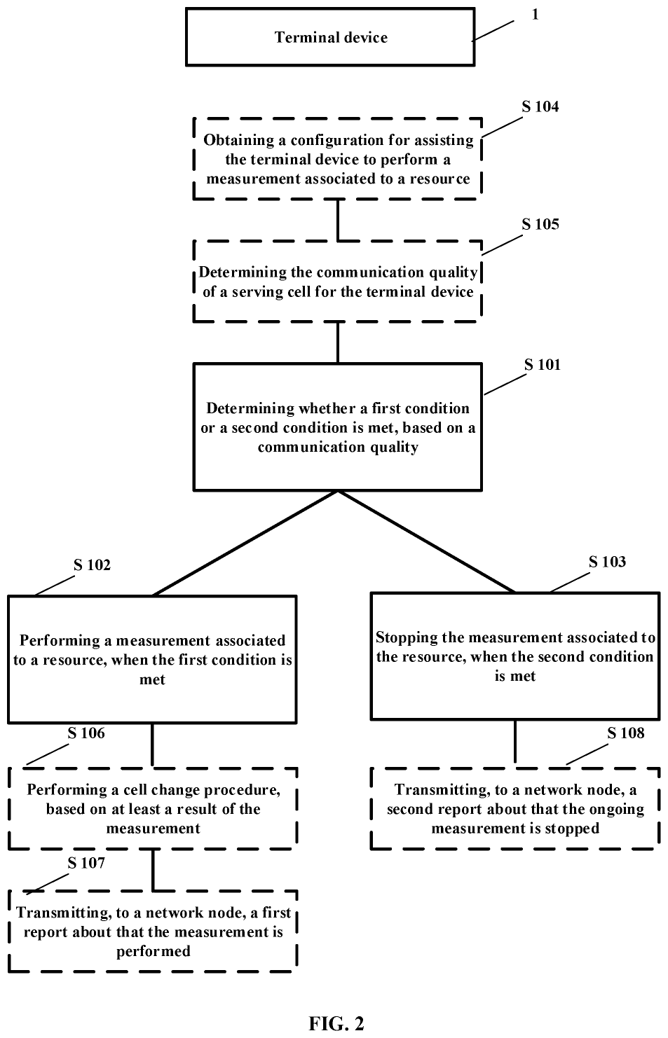

FIG. 2 is an exemplary flow chart showing a method performed at a terminal device, according to embodiments of the present disclosure. The dashed blocks may be optional.

As shown in FIG. 2, a method performed at a terminal device may comprises: determining (S101) whether a first condition or a second condition is met, based on a communication quality; and performing (S102) a measurement associated to a resource, when the first condition is met, or stopping (S103) the measurement associated to the resource, when the second condition is met.

According to embodiments of the present disclosure, the measurement may be performed or stopped under a first condition or a second condition. The time and power may be saved.

In embodiments of the present disclosure, the resource comprises: at least one carrier frequency; and/or at least one cell.

In embodiments of the present disclosure, the method further comprises: obtaining (S104) a configuration for assisting the terminal device to perform a measurement associated to a resource.

According to embodiments of the present disclosure, the configuration may be obtained previously, and thus the time consuming for the measurement may be further reduced.

In embodiments of the present disclosure, the configuration comprises at least one of: at least one identifier of the at least one carrier frequency; at least one identifier of the at least one cell; and a type of the measurement.

In embodiments of the present disclosure, the configuration further comprises at least one of: a source cell reference signal received power, RSRP, threshold for initiating a reestablishment procedure; a source cell reference signal received quality, RSRQ, threshold for initiating a reestablishment procedure; a target cell RSRP threshold; a target cell RSRQ threshold; or system information of the at least one cell.

In embodiments of the present disclosure, the configuration comprises at least one parameter associated to the first condition; and the at least one parameter includes at least one of: an operation mode; a coverage level; and a network capacity.

According to embodiments of the present disclosure, under different operation modes, coverage levels, and/or network capacities, the measurement may be performed differently.

In embodiments of the present disclosure, the configuration is received from a network node.

In embodiments of the present disclosure, the network node provides the serving cell for the terminal device.

In embodiments of the present disclosure, the configuration is determined based on a rule.

In embodiments of the present disclosure, the method further comprises: determining (S105) the communication quality of a serving cell for the terminal device. The communication quality of the serving cell is determined by measuring a reference signal including at least one of: a narrowband reference signal, NRS; a narrowband secondary synchronization signal, NSSS; and a narrowband physical broadcast channel, NPBCH.

In embodiments of the present disclosure, the first condition comprises that a first event is triggered.

In embodiments of the present disclosure, the first condition comprises that a first event is triggered and at least a first period has elapsed since a triggering of the first event.

In embodiments of the present disclosure, a first timer and/or a first counter is started upon the triggering of the first event; and the first period has elapsed when the first timer expires and/or when the first counter reaches a set value.

In embodiments of the present disclosure, the first event is trigged when the communication quality is equal to or lower than a first threshold; and the first threshold is equal to or higher than a value indicating that the terminal device is out of synchronization.

According to embodiments of the present disclosure, the measurement may be performed just when the terminal device is out of synchronization or before the terminal device is out of synchronization, the latency for the measurement may be further reduced.

In embodiments of the present disclosure, the first event is cancelled when a second event is triggered.

In embodiments of the present disclosure, the second event is trigged when the communication quality is equal to or higher than a second threshold; and the second threshold is equal to or higher than a value indicating that the terminal device is in synchronization.

According to embodiments of the present disclosure, the measurement may be cancelled when the communication quality is recovered, thus, the power of the terminal device may be further saved.

In embodiments of the present disclosure, the method further comprises: performing (S106) a cell change procedure, based on at least a result of the measurement; and the cell change procedure includes at least one of: a radio resource control, RRC, re-establishment; an RRC release with redirection; and a handover.

According to embodiments of the present disclosure, the result of the measurement may be an important information for cell change procedure. For example, the result may show which cell has a rather better communication quality. Thus, an appropriate cell may be selected, and the latency of the cell change procedure may be also reduced.

In embodiments of the present disclosure, the method further comprises: transmitting (S107), to a network node, a first report about that the measurement is performed.

In embodiments of the present disclosure, the first report further comprises information about at least of: a cell, on which the measurement is performed; and a triggering condition for performing the measurement.

In embodiments of the present disclosure, the first report further comprises information about whether the terminal device is stationary or mobile.

In embodiments of the present disclosure, the terminal device stops an ongoing measurement being performed or to be performed, when a second condition is met.

In embodiments of the present disclosure, the second condition comprises that a second event is triggered.

In embodiments of the present disclosure, the second condition comprises that the second event is triggered and at least a second period has elapsed since the triggering of the second event.

In embodiments of the present disclosure, a second timer and/or a second counter is started upon the triggering of the second event; and the second period has elapsed when the second timer expires and/or when the second counter reaches a set value.

In embodiments of the present disclosure, the terminal device stops the ongoing measurement after an ongoing measurement activity is completed.

In embodiments of the present disclosure, the ongoing measurement activity comprises: a detection of a cell; or a layer 1 measurement.

In embodiments of the present disclosure, the method further comprises: transmitting (S108), to a network node, a second report about that the ongoing measurement is stopped.

In embodiments of the present disclosure, the second report further comprises information about at least one of: a cell, to which the ongoing measurement is associated; and a triggering condition for stopping the ongoing measurement.

In embodiments of the present disclosure, the second report further comprises information about whether the terminal device is stationary or mobile.

According to embodiments of the present disclosure, information about the measurement (either performed or stopped) is reported to the network node, and the network node may operate accordingly. Thus, relevant procedure may be started to further reduce time and/or power consuming.

In embodiments of the present disclosure, whether the terminal device is stationary or mobile is indicated by a communication pattern parameter.

In embodiments of the present disclosure, the measurement is performed if the terminal device is mobile, and a maximum repetition number, Rmax, of the terminal device is prolonged, if the terminal device is stationary.

In embodiments of the present disclosure, the terminal device comprises a narrow band internet of things, NB-IoT, device.

According to embodiments of the present disclosure, the NB-IoT device, either stationary or mobile, may be improved.

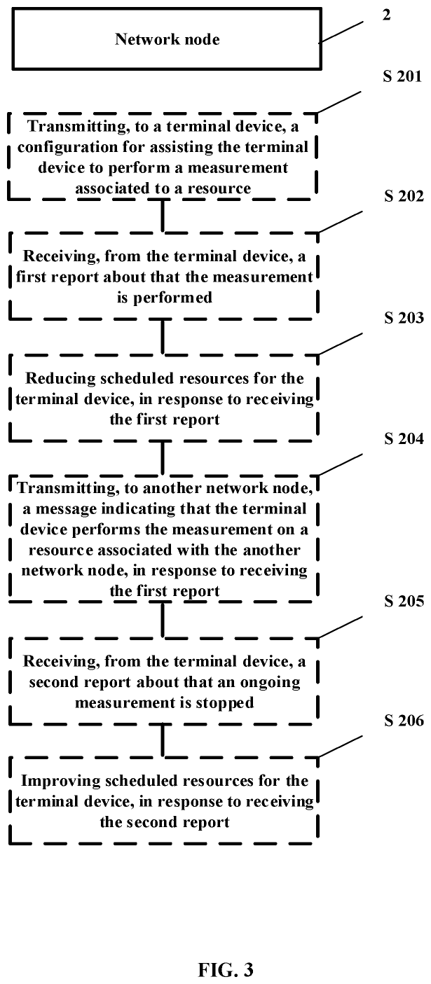

FIG. 3 is an exemplary flow chart showing a method performed at a network node, according to embodiments of the present disclosure.

As shown in FIG. 3, a method performed at a network node may comprise: transmitting (S201), to a terminal device, a configuration for assisting the terminal device to perform a measurement associated to a resource.

In embodiments of the present disclosure, the resource comprises: at least one carrier frequency; and/or at least one cell.

In embodiments of the present disclosure, the configuration comprises at least one of: at least one identifier of the at least one carrier frequency; at least one identifier of the at least one cell; and a type of the measurement.

In embodiments of the present disclosure, the configuration further comprises at least one of: a source cell reference signal received power, RSRP, threshold for initiating a reestablishment procedure; a source cell reference signal received quality, RSRQ, threshold for initiating a reestablishment procedure; a target cell RSRP threshold; a target cell RSRQ threshold; or system information of the at least one cell.

According to embodiments of the present disclosure, the configuration about a measurement may be transmitted to the terminal device previously, and thus the time consuming for the measurement may be further reduced.

In embodiments of the present disclosure, the configuration comprises at least one parameter associated to the first condition; and the at least one parameter includes at least one of: an operation mode; a coverage level; and a network capacity.

In embodiments of the present disclosure, the network node provides the serving cell for the terminal device.

In embodiments of the present disclosure, the configuration is determined based on a rule.

In embodiments of the present disclosure, the method further comprises: receiving (S202), from the terminal device, a first report about that the measurement is performed.

In embodiments of the present disclosure, the first report further comprises information about at least of: a cell, on which the measurement is performed; and a triggering condition for performing the measurement.

In embodiments of the present disclosure, the first report further comprises information about whether the terminal device is stationary or mobile.

In embodiments of the present disclosure, the method further comprises: reducing (S203) scheduled resources for the terminal device, in response to receiving the first report; and/or transmitting (S204), to another network node, a message indicating that the terminal device performs the measurement on a resource associated with the another network node, in response to receiving the first report.

According to embodiments of the present disclosure, information about the measurement performed is reported to the network node, and the network node may operate accordingly. Thus, relevant procedure may be started to further reduce time and/or power consuming. For example, the terminal device, which is going to change the cell, will be scheduled with less communication resources in the current cell, to improve the usage efficiency of the resources. Further, another network node, to which the terminal device may access later, will be informed and prepared previously.

In embodiments of the present disclosure, the method further comprises: receiving (S205), from the terminal device, a second report about that an ongoing measurement is stopped.

In embodiments of the present disclosure, the second report further comprises information about at least one of: a cell, to which the ongoing measurement is associated; and a triggering condition for stopping the ongoing measurement.

In embodiments of the present disclosure, the second report further comprises information about whether the terminal device is stationary or mobile.

In embodiments of the present disclosure, the method further comprises: improving (S206) scheduled resources for the terminal device, in response to receiving the second report.

According to embodiments of the present disclosure, information about the measurement stopped is reported to the network node, and the network node may operate accordingly. Thus, relevant procedure may be started. For example, the terminal device, which is going to stay in the current cell, will be scheduled with more communication resources in the current cell.

In embodiments of the present disclosure, whether the terminal device is stationary or mobile is indicated by a communication pattern parameter.

In embodiments of the present disclosure, the measurement is performed if the terminal device is mobile, and a maximum repetition number, Rmax, of the terminal device is prolonged, by the network node, if the terminal device is stationary.

In embodiments of the present disclosure, the network node comprises a base station; and/or the terminal device comprises a narrow band internet of things, NB-IoT, device.

Some more detailed embodiments of the present disclosure will be further illustrated bellow with reference to figures.

In some embodiments a more general term “network node” is used and it can correspond to any type of radio network node or any network node, which communicates with a UE and/or with another network node. Examples of network nodes are NodeB, Master Evolved Node B, MeNB, Secondary eNB, SeNB, a network node belonging to Master Cell group, MCG or Secondary Cell group, SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, Radio Remote Unit, RRU, Radio Remote Head, RRH, nodes in distributed antenna system (DAS), core network node (e.g. mobile switching center, MSC, mobility management entity, MME, etc), Operation and Maintenance, O&M, Operation Support System, OSS, self-organized network, SON, positioning node (e.g. Enhanced Serving Mobile Location Centre, E-SMLC), Minimization Drive Test, MDT, test equipment (physical node or software), etc.

In some embodiments the non-limiting term user equipment (UE) or wireless device is used, and it refers to any type of wireless device communicating with a network node and/or with another UE in a cellular or mobile communication system. Examples of UE are target device, device to device (D2D) UE, machine type UE or UE capable of machine to machine (M2M) communication, Personal Digital Assistant, PDA, Portable Device, PAD, Tablet, mobile terminals, smart phone, laptop embedded equipped (LEE), laptop mounted equipment (LME), Universal Serial Bus, USB dongles, Proximity-based services (ProSe) UE, vehicle to vehicle, V2V UE, vehicle to everything, V2X UE, etc.

The embodiments are described for LTE e.g. MTC and NB-IoT. However, the embodiments are applicable to any Radio Access Technology, RAT or multi-RAT systems, where the UE receives and/or transmit signals (e.g. data) e.g. LTE FDD/TDD (Frequency Division Duplex/Time Division Duplex), WCDMA/HSPA (Wideband Code Division Multiple Access/High-Speed Packet Access), GSM/GERAN (Global System for Mobile Communication/GSM EDGE Radio Access Network), Wi Fi, WLAN (Wireless Local Area Network), CDMA2000 (Code Division Multiple Access 2000), 5G (5^{th} generation), NR (new radio), etc.

The term time resource used herein may correspond to any type of physical resource or radio resource expressed in terms of length of time. Examples of time resources are: symbol, mini-slot, time slot, subframe, radio frame, transmission time interval, TTI, short TTI, interleaving time, etc.

The scenario comprising a UE served by a first cell (cell1). Celli is managed or served or operated by a network node (NW1) e.g. a base station. The UE operates in a certain coverage enhancement (CE) level with regard to a certain cell e.g. with regard to cell1. The UE is configured to receive signals (e.g. paging, Wake up Service, WUS, NPDCCH, NPDCCH, PDSCH etc.) from at least cell1. The UE may further be configured performing one or more measurement on cell1 and one or more additional cells e.g. neighbor cells.

In the embodiments, the methods in a UE for initiating measurements may be further illustrated.

This embodiment discloses a method in a UE for triggering or initiating the neighbor cell measurements during radio link monitoring procedure. The overall method can be summarized as follows: obtaining a measurement configuration indicating the neighbor cells; performing measurement on downlink reference signals of the serving cell to estimate DL link quality; evaluating one or more RLM related events using the serving cell measurements; initiating the neighbor cell measurements based on the evaluation result; and optionally, reporting the result of the evaluation to the serving network node.

It should be understood, the method in the UE mentioned above is also for triggering or initiating the current serving cell measurements during radio link monitoring procedure, and similar steps will not be described again.

For obtaining a measurement configuration indicating the neighbor cells, the UE obtains information about at least one neighbor cell on which the UE may have to perform one or more measurements when certain condition is met e.g. upon triggering of RLM related event. The information may also be called as measurement configuration. In general, the information may further comprise one or more of: a set of carriers for the UE to search and measure, a set of neighbor cells for UE to search and measure etc. For example the measurement configuration may comprise one or more of: an identifier of a carrier frequency of the neighbor cells on which measurements are to be performed (e.g. carrier frequency channel number, Absolute RF Channel Number, ARFCN, E-UTRA Absolute Radio Frequency Channel Number, EARFCN etc), identifier of neighbor cells (e.g. physical cell identifier, PCI, Cell Global Identifier, CGI etc), type of measurement to be performed (e.g. NRSRP, NRSRQ etc) etc.

The configuration may also depend on or associated with one or more factors, such as e.g. operational scenario or mode in which the UE is operating in the serving cell (e.g. standalone mode, in-band mode, guardband mode etc), the coverage enhancement level of the UE with regard to a cell (e.g. normal coverage, enhanced coverage etc), network capacity (e.g. number of UEs per cell), etc.

In one example the measurement configuration is obtained by the UE by receiving a message from the network node (NW), e.g. from broadcast or dedicated signaling. It may also be requested by the UE and in this case the NW may provide it to the UE in response to the UE's request.

In another example the measurement configuration is obtained by the UE based on a rule which can be pre-defined or configured by the network node. Examples of such rules indicate: neighbor cells comprising cells of the carrier of the serving cell of the UE; and/or neighbor cells comprising cells of one or more carriers which were configured for measurements in low activity state e.g. in RRC idle state, RRC inactive state etc. These carriers can be adjacent or separated by some offset.

For example, all possible cells located in the intra frequency carrier may be measured.

In another example the measurement configuration is obtained by the UE based on statistics or historical information. For examples neighbor cells on which the UE has performed the measurements recently, in the last TO period (which is arbitrary) e.g. in the last 30 minutes.

For performing measurement on downlink reference signals of the serving cell to estimate DL link quality, the wireless device (UE) is performing measurement on the downlink reference signals of the serving cell. The RLM procedure requires the UE to estimate the downlink link quality which is denoted as quality of link, QL. UE can measure on downlink reference symbols like NRS which are typically on anchor carrier on certain subframes with certain periodicities, while they are transmitted on the non-anchor carrier upon certain events, e.g. UE being paged. NRS measurements are typically used to estimate the downlink channel and is also used to perform NRSRP measurement.

Although this step is exemplified for NRS signals, the same method also applies to other type of reference signals such like NSSS, NPBCH. The measurement is typically a signal quality (e.g. Signal to Interference plus Noise Ratio, SINR, Signal Noise Ratio, SNR, RSRQ etc.) indicating the signal to noise ratio of the serving cell radio link.

For evaluating RLM events using the serving cell signal quality, the UE applies the measurement result from the previous step in the RLM procedure. There are two target thresholds which correspond to X1% block error rate and Y1% block error rate (BLER) of hypothetical DL control channel e.g. NPDCCH transmissions, PDCCH transmission etc. The first BLER target, X1%, corresponds to out-of-sync, i.e. the BLER level at which the downlink radio link cannot be reliably received. The second target BLER, Y1%, correspond to the BLER level at which the downlink radio link can be reliably received. Example of X1 corresponds to 10% block error rate of the hypothetical control channel and example of Y1 correspond to 2% block error rate of the hypothetical control channel. The UE may further be configured to trigger enhanced RLM events e.g. early Qout (Event E1) and early Qin (Event E2). The enhanced RLM events are configured with one or more parameters which enables the UE to trigger one or more events prior to out-of-sync and in-sync detections. For example, Event E1 may be triggered when the signal quality is slightly higher than that corresponding to out-of-sync threshold i.e. triggered before the actual OOS detection. Similarly, for example Event E2 may be triggered when the signal quality is slightly higher than that corresponding to in-sync threshold. An example of the transmission parameters used for evaluating the RLM for events E1 and E2 is shown in table 3:

TABLE 3
Example of NPDCCH transmission parameters for event E1 and
event E2 for UE category NB1 [3GPP TS 36.133 v16.6.0]

| Attribute | Event E1 | | Event E2 | |
|---|---|---|---|---|
| DCI format | Format N1 | | Format N1 | |
| Number of information bits | 23 | bits | 23 | bits |
| System Bandwidth | 200 | kHz | 200 | kHz |

| | | |
|---|---|---|
| Antenna configuration | 2 × 1 | 2 × 1 |
| Maximum NPDCCH Repetition level | Rₘₐₓ/2 ^{Note1} | Rₘₐₓ/8 ^{Note1} |
| Aggregation level | 2 | 2 |
| DRX | OFF | OFF |

^{Note1}
Rₘₐₓ is a configurable parameter. It is determined by the configurable parameter NPDCCH-NumRepetition defined in 3GPP TS 36.331 v16.1.1.

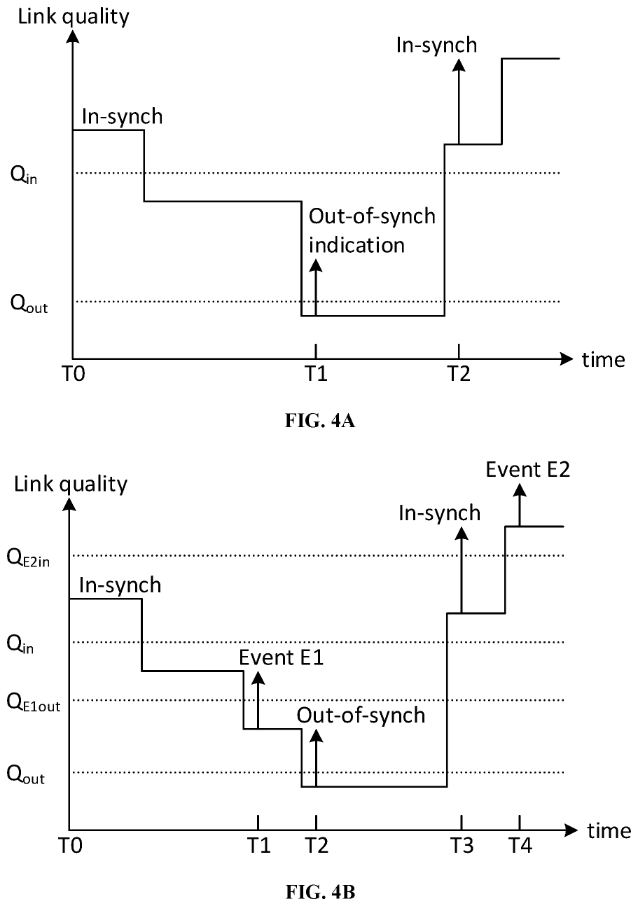

FIG. 4A is an exemplary diagram showing a relation of out-of-synchronization (Qout) and in-synchronization (Qin); FIG. 4B is an exemplary diagram further showing a relation of out-of-synchronization (Qout), in-synchronization (Qin), event1 (Q_{E1out}), and event2 (Q_{E2in}).

As shown in FIG. 4A, when UE is equal to, or less than the Qout threshold, the UE is out-of-synchronization. When UE is equal to, or higher than the Qin threshold, the UE is in-synchronization.

As shown in FIG. 4B, event E1 and E2 (also referred as enhanced RLM event monitoring) can be summarized are follows:

Event E1 which is triggered when UE is ‘X’ dB above the Qout threshold, where X is an SNR/SINR value that is higher than the SNR/SINR value at which the Qout is triggered (i.e., X=Q_{E1out}−Qout in FIG. 4B). This means that the event E1 (sometimes also referred as early Qout) is triggered earlier than Qout event in legacy RLM procedure as described. In yet another example, X can represent hypothetical BLER of the control channel (e.g. machine physical downlink control channel, MPDCCH, PDCCH, NPDCCH) in which case the event is triggered based on the measured or estimated BLER which is in turn based on the SNR/SINR of reference signal measurement. In this case, the value of X may be smaller (e.g. 7% or 8%) compared to the hypothetical BLER target at which the Qout event (10%) is triggered in legacy RLM procedure.

Event E2 which is triggered when UE is ‘Y’ dB above the Qin threshold, where Y is an SNR/SINR value that is higher than the SNR/SINR value at which the Qin is triggered (i.e., Y=Q_{E2in}−Qin in FIG. 4B. This means that the event E2 (sometimes also referred as early Qin) is triggered after Qin event in legacy RLM procedure as described. In yet another example, Y can represent hypothetical BLER of the control channel (e.g. MPDCCH, PDCCH, NPDCCH) in which case the event is triggered based on the measured or estimated BLER which is in turn based on the SNR/SINR of reference signal measurement. In this case, the value of Y may be smaller (e.g. 1%) compared to the hypothetical BLER target at which the Qin event (2%) is triggered in legacy RLM procedure.

The conditions for initiating neighbor cell measurements are described below.

If the evaluation results in triggering of event E1 then the UE initiates the measurements one or more cells whose configuration is obtained by the UE in the earlier step. If such configuration is missing, the UE may initiate measurements on neighbor cells by searching for cells based on the signal strength, blind search, historical information, Automatic Neighbor Relation, ANR information etc. In practice, event E1 is triggered when the channel condition starts to become poor or with lower reliability compared to in-sync indication. This may the case when the UE is moving out of the coverage of the serving cell, moving away from the serving network node, or the interference may have increased in the cell. This means, the hypothetical BLER of NPDCCH may be in the range: 2%≤hypothetical NPDCCH BLER≤10%. This may eventually lead to radio link failure and therefore loss of the serving cell. In such scenario, there is an advantage for the UE to start measuring on the neighbor cells as this can help the UE to prepare for the possible re-establishment of the RRC connection to a neighbor cell. In this example, the UE initiates the neighbor cell measurements upon triggering of event E1. This approach avoids the UE to perform neighbor cell measurements on regular basis and therefore saves UE battery power, reduces UE complexity and processing. The UE uses the procedure of channel quality report to report Event E1 or based upon MAC CE for quality report, QR as shown.

In another example the UE may not start the neighbor cell measurements immediately upon triggering the early Qout event e.g. event E1. Instead the UE starts a timer upon triggering event E1 and starts the neighbor cell measurements upon expiry of that timer. Since measurements of neighbor cell can be power consuming for an IoT device like NB-IoT, any unnecessary or redundant measurements should be avoided. Having a timer linked to E1 event is an additional mechanism to ensure that the measurements are started only when necessary. The timer value can be pre-defined or configured by the network node. The timer can be reset (e.g. initialized to certain value e.g. set to 0) when one or more conditions is met. Examples of such conditions are: upon detecting M1 number of in-sync, when serving cell's signal quality (e.g. SNR, SINR etc) becomes larger than certain threshold, upon triggering an event (e.g. Event E2), when RLF timer is stopped or reset (e.g. T310 is stopped etc).

Upon triggering the event E1 or expiry of timer followed by Event E1, the UE starts the measurements on the one or more neighbor cells. The measurement may comprise detecting the cells and may further comprise performing one or more signal measurements. If the UE cannot detect any cell on the carriers configured for measurements then the UE may perform cell selection e.g. detection of any cells on any carrier, detection of cells on carrier preconfigured for cell selection etc.

The UE may further use the measurements results for performing the cell change to the neighbor cell. Examples of cell change are RRC connection re-establishment, RRC release with redirection, handover etc.

In one example, UE starts the measurements on the one or more neighbour cells when Qout (out-of-sync) conditions is met. In yet another example, upon the Qout indications, the UE starts a timer and UE starts the neighbor cell measurements upon expiry of that timer. In yet another example, upon the Qout indications, the starts the neighbor cell measurements after K1 number of OoS (out-of-sync) indications (for example, a counter will be used for counting this number).

For optionally reporting the result of the evaluation triggering the measurements to NW node, the UE may further inform the network node that it has initiated the neighbor cell measurements. In one example the information may comprise an indicator that it has initiated the measurements. In another example the information may further comprise information about the cells on which it has initiated the measurements. The UE may further transmit the results of events (e.g. Event E1) that has triggered the measurements, to the network node. The network node may use the received information for one or more tasks. Examples of tasks comprising: adapting scheduling of signals to the UE, transmitting or preparing to transmit UE context to the neighbor cell that may become potential new serving cell of the UE etc. For example, the NW may use this for selective scheduling of resources. For example, the NW node may schedule the UE with not more than certain duty cycle (no more than X % of the time resource) in the serving cell while the UE is doing the neighbor cell measurements. The value of X can be pre-defined or configured by the network node. This will reduce UE power consumption and complexity. This will also prevent data loss in case the UE has to do RRC re-establishment to a neighbor cell.

Further, the methods in a UE for stopping ongoing neighbor cell measurements may be illustrated.

According to embodiments, the UE determines that it is performing measurements on one or more neighbor cells, and stops the ongoing measurements based on enhanced RLM event.

For determining the ongoing neighbor cell measurements, the UE determines if the UE is performing or about to perform measurements on or more neighbor cells. In one example the UE determines this based on a triggering of condition or criteria that has resulted in the start of the neighbor cell measurements. Examples of such conditions are event E1, occurrence of radio link failure (e.g. expiry of RLF timer), start of RLF timer, M2 number of OOS detection, serving cell's signal level (e.g. NRSRP, NRSRQ, CQI etc.) falls below certain threshold etc. The relationship between the triggering of conditions and start of the neighbor cell measurements can be defined by a rule. In another example the UE determines this upon detecting a new cell e.g. a neighbor cell.

For stopping the neighbor cell measurements based on the evaluation result, the conditions for stopping the neighbor cell measurements are described below.

In order to reduce the neighbor cell measurements, and thereby reducing unnecessary power consumption in the UE, it is important to stop those measurements when the radio conditions of the serving cell have improved.

In one example if the evaluation has resulted in triggering of event E2 then the UE stops the neighbor cell measurements. In one example, the UE may stop, cancel, suspend or defer all ongoing measurement activities immediately (e.g. filtering of samples, collecting of samples) when event E2 is triggered.

In another example, the UE completes the ongoing measurement activities, and thereafter stops, cancels, suspends or defer the measurements. For example, the UE may complete the detection of the cell and after that it may stop the measurement. In another example the UE may complete the L1 measurement of the detected cell and after that it may stop the measurement. Examples of L1 measurements are signal strength (e.g. NRSRP), signal quality (e.g. NRSRQ) etc.

In yet another example, the UE starts a timer upon triggering of event E2 and stops, cancels, suspends or defer the measurements upon the expiry of timer. The value of timer can be pre-defined or configured by the network node. The use of the timer prevents ping pong effect by avoiding the UE from frequent switching between performing the measurement and not performing the measurements on neighbor cells.

In yet another example if the evaluation has resulted in that UE has fulfilled the Qin (in-sync) conditions, then the UE stops the neighbor cell measurements. In one example, the UE may stop, cancel, suspend or defer all ongoing measurement activities immediately (e.g. filtering of samples, collecting of samples) when in-sync is triggered. In another example, the UE may stop, cancel, suspend or defer the neighbor cell measurement activities after K2 number of in-sync indications (for example, a counter may be used).

In practice, event E2 is triggered when the UE is operating under good coverage towards the serving cell (e.g. higher SNR) and UE can receive the control channel with higher reliability compared to the scenario when the UE detects out-of-sync or early Qout. This may be the case when the UE is moving to an improved coverage area, closer to the serving network node, or when the interference level in the cell has reduced. In this case, the hypothetical BLER of the control channel (e.g. NPDCCH) may be lower than when event E1 (early Qout) is triggered. The UE uses the procedure of channel quality report to report Event E1 or based upon MAC CE for QR as shown below. In such scenario, stopping the neighbor cell measurement activities reduces the power consumption in the UE while the measurement performance is maintained. This in turn improves mobility performance while without excessively increasing UE battery power and UE complexity.

FIG. 5 is an examplary diagram showing an downlink channel quality report, DCQR and Access Stratum Release Assistance Indication Medium Access Control, AS RAI MAC control element.

For optionally reporting the result of the evaluation to the serving network node, the UE may further inform the network node that it has stopped or cancels or suspended or deferred or delayed the ongoing neighbor cell measurements. In one example the information may comprise an indicator that it has stopped or suspended the measurements. In another example the information may further comprise information about the cells on which it has stopped or suspended the measurements. The UE may further transmit the results of events (e.g. Event E2) that has triggered the stopping or suspension of the measurements, to the network node. The network node may use the received information for one or more tasks. Examples of tasks comprising: adapting scheduling of signals to the UE etc. For example, the NW may use this for scheduling of any resources. For example, the NW node may schedule the UE without any restriction e.g. in any time resources in the serving cell.

As shown in FIG. 5, there are 2 reserved bits available in MAC CE. It is possible to indicate one of the R (reserved) bits to indicate that instead of QR; earlyQin/Qout have been used; thus, this provides 16 code points.

Alternative is to use for QR and also event E1/E2 indication as shown below in table 4. There are 4 code points available which can be used below as in table 4.

TABLE 4
Values for EarlyQout/Qin Events (E1/E2)

| Codepoint/Index | Value |
|---|---|
| 00 | No EarlyQout/Qin information |
| 01 | Stationary UE Event E1/E2 |
| 10 | Mobile UE Event E1/E2 |
| 11 | Reserved |

For the first time; it is event E1 that UE notifies; further the UE can inform if it is stationary or mobile UE. For the second time if UE meets E2 (or in-sync) then it reports that to the NW.

The stationary/mobile UE differentiation may also be possible to perform based upon UE subscription information. In such case it is possible to design the UE reporting such that UE informs just events and no indication of stationary/mobile.

The subscription-based info is provided below.

In TS 23.682 V16.6.0 which is incorporated herein by reference in its entirety, the subscription-based info on stationary indication is specified as below.

As to “Communication Pattern parameters provisioning procedure”, further as to “Communication Pattern parameters”, a set of Communication Pattern (CP) parameters is defined in the table below. All CP parameters are optional.

These CP parameters are specific for a UE or a group of UEs. Sets of these CP parameters are provided by the SCEF to the HSS which distributes them to the corresponding MME with relevant subscriber data. The MME considers the sets of CP parameters (e.g. by merging per CP parameter if multiple sets are present), before using the parameters. Each CP parameter set shall have an associated validity time. The validity time indicates when the CP parameter set expires and shall be deleted by the HSS/MME. The validity time may be set to a value indicating that the particular CP parameter set has no expiration time. When the validity time expires, the involved nodes (SCEF, HSS, and MME) autonomously delete the associated CP parameter set with no additional signalling between the involved nodes.

NOTE: It is expected that the format of validity time, to be defined by Stage 3, is defined in a manner which allows SCEF, HSS and MME/SGSN to consistently and uniformly interpret the expiration of the associated CP parameters set.

TABLE 5.10.1-1
CP parameters (of TS 23.682 V16.6.0)

| CP parameter | Description |
|---|---|
| 1) Periodic communication | Identifies whether the UE communicates periodically or |
| indicator | not, e.g. only on demand. [optional] |
| 2) Communication | Duration interval time of periodic communication |
| duration time | [optional, may be used together with 1)] |
| | Example: 5 minutes |
| 3) Periodic time | Interval Time of periodic communication [optional, may |
| | be used together with 1)] |
| | Example: every hour |
| 4) Scheduled | Time zone and Day of the week when the UE is available |
| communication time | for communication [optional] |
| | Example: Time: 13:00-20:00, Day: Monday |
| 5) Stationary | Identifies whether the UE is stationary or mobile |
| indication | [optional] |
| 6) Battery | Identifies power consumption criticality for the UE: if the |
| indication | UE is battery powered with not rechargeable/not |
| | replaceable battery, battery powered with |
| | rechargeable/replaceable battery, or not battery powered. |
| | [optional] |

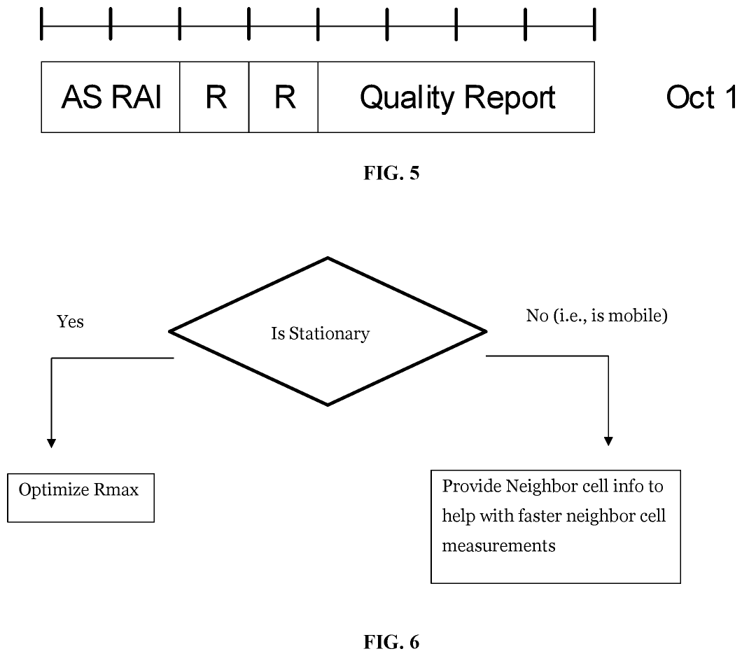

FIG. 6 is an exemplary flow chart showing separate actions of network node for different type of terminal devices.

Based upon such distinction between stationary and mobile UE, the eNB takes separate actions.

For example, for stationary case, the serving cell Rmax can be prolonged/enlarged and for mobile UEs neighbor cell measurement can be provided.

Particularly, the neighbor cell parameters for neighbor cell measurement may include: Carrier Frequencies EARFCNs; Potential Neighbor Cells; Source Cell RSRP threshold before initiating reestablishment procedure; Target Cell RSRP threshold margin compared to source cell or an absolute value; System Information of potential target cells. With such information, the neighbor cell measurement may be performed faster.

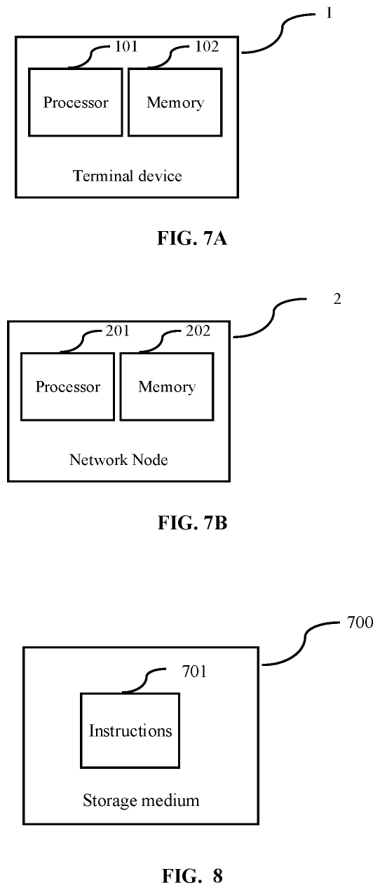

FIG. 7A is a block diagram showing exemplary apparatuses suitable for practicing the terminal device according to embodiments of the disclosure. FIG. 7B is a block diagram showing exemplary apparatuses suitable for practicing the network node according to embodiments of the disclosure.

As shown in FIG. 7A, the terminal device 1 may comprise: a processor 101; and a memory 102. The memory 102 contains instructions executable by the processor 101, whereby the terminal device is operative to determine whether a first condition or a second condition is met, based on a communication quality; and perform a measurement associated to the resource, when the first condition is met, or stop the measurement associated to the resource, when the second condition is met.

Further, the terminal device 1 may be operative to perform the method according to any of the above embodiments, such as these shown in FIG. 2.

As shown in FIG. 7B, the network node 21 may comprise: a processor 201; and a memory 202. The memory 202 contains instructions executable by the processor 201, whereby the network node is operative transmit, to a terminal device, a configuration for assisting the terminal device to perform a measurement associated to a resource.

Further, the network node 2 may be operative to perform the method according to any embodiment of the above embodiments, such as these shown in FIG. 3.

The processors 101, 201, may be any kind of processing component, such as one or more microprocessor or microcontrollers, as well as other digital hardware, which may include digital signal processors (DSPs), special-purpose digital logic, and the like. The memories 102, 202, may be any kind of storage component, such as read-only memory (ROM), random-access memory, cache memory, flash memory devices, optical storage devices, etc.

FIG. 8 is a block diagram showing an apparatus readable storage medium, according to embodiments of the present disclosure.

As shown in FIG. 8, the computer-readable storage medium 700, or any other kind of product, storing instructions 701 which when executed by at least one processor, cause the at least one processor to perform the method according to any one of the above embodiments, such as these shown in FIG. 2-3.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

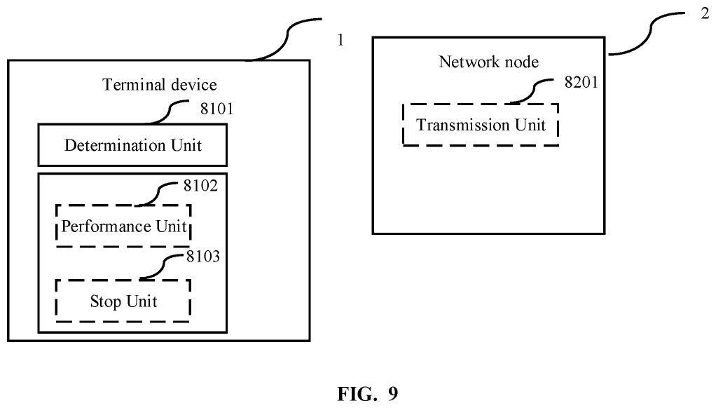

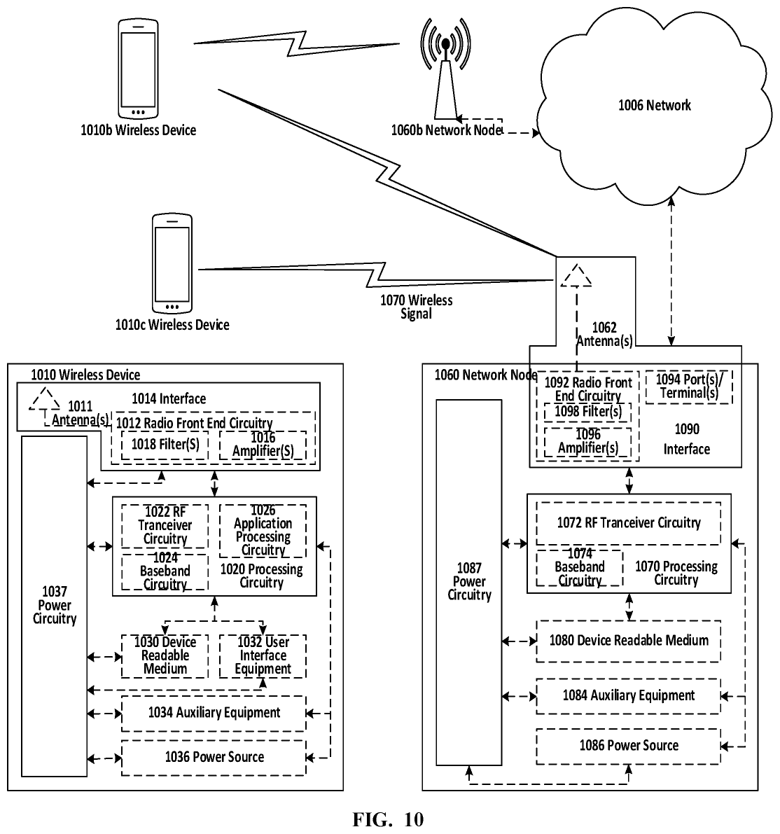

FIG. 9 is a schematic showing units for the terminal device, the first network node, according to embodiments of the present disclosure.

In embodiments of the present disclosure, the terminal device 1 may comprise: a determination unit 8101, configured to determine whether a first condition or a second condition is met, based on a communication quality; and a performance unit 8102, configured to perform a measurement associated to the resource, when the first condition is met, or a stop unit 8103, configured to stop the measurement associated to the resource, when the second condition is met.

In embodiments of the present disclosure, the terminal device is further operative to perform the method according to any of embodiments above described.

In embodiments of the present disclosure, the network node 2 may comprise: a transmission unit 8201, configured to transmit, to a terminal device, a configuration for assisting the terminal device to perform a measurement associated to a resource.

In embodiments of the present disclosure, the first network node is further operative to perform the method according to any of embodiments above described.

The term ‘unit’ may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With these units, the terminal device 1 and the network node 2, may not need a fixed processor or memory, any computing resource and storage resource may be arranged from at least one network node/device/entity/apparatus relating to the communication system. The virtualization technology and network computing technology (e.g. cloud computing) may be further introduced, so as to improve the usage efficiency of the network resources and the flexibility of the network.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Particularly, these function units may be implemented either as a network element on a dedicated hardware, as a software instance running on a dedicated hardware, or as a virtualized function instantiated on an appropriate platform, e.g. on a cloud infrastructure.

According to embodiments of the present disclosure, methods and apparatuses for performing a measurement associated to a resource, particularly, for adaptively performing neighbor cell measurements for NB-IoT, may be provided.

FIG. 10 is a schematic showing a wireless network in accordance with some embodiments.

Although the subject matter described herein may be implemented in any appropriate type of system using any suitable components, the embodiments disclosed herein are described in relation to a wireless network, such as the example wireless network illustrated in FIG. 10. For simplicity, the wireless network of FIG. 10 only depicts network 1006, network nodes 1060 (corresponding to a network node 2) and 1060b, and WDs 1010, 1010b, and 1010c (corresponding to a terminal device 1). In practice, a wireless network may further include any additional elements suitable to support communication between wireless devices or between a wireless device and another communication device, such as a landline telephone, a service provider, or any other network node or end device. Of the illustrated components, network node 1060 and wireless device (WD) 1010 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1006 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1060 and WD 1010 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 10, network node 1060 includes processing circuitry 1070, device readable medium 1080, interface 1090, auxiliary equipment 1084, power source 1086, power circuitry 1087, and antenna 1062. Although network node 1060 illustrated in the example wireless network of FIG. 10 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1060 are depicted as single boxes located within a larger box, or nested within multiple boxes, in practice, a network node may comprise multiple different physical components that make up a single illustrated component (e.g., device readable medium 1080 may comprise multiple separate hard drives as well as multiple RAM modules).

Similarly, network node 1060 may be composed of multiple physically separate components (e.g., a NodeB component and a RNC component, or a BTS component and a BSC component, etc.), which may each have their own respective components. In certain scenarios in which network node 1060 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1060 may be configured to support multiple radio access technologies (RATs). In such embodiments, some components may be duplicated (e.g., separate device readable medium 1080 for the different RATs) and some components may be reused (e.g., the same antenna 1062 may be shared by the RATs). Network node 1060 may also include multiple sets of the various illustrated components for different wireless technologies integrated into network node 1060, such as, for example, GSM, WCDMA, LTE, NR, WiFi, or Bluetooth wireless technologies. These wireless technologies may be integrated into the same or different chip or set of chips and other components within network node 1060.

Processing circuitry 1070 is configured to perform any determining, calculating, or similar operations (e.g., certain obtaining operations) described herein as being provided by a network node. These operations performed by processing circuitry 1070 may include processing information obtained by processing circuitry 1070 by, for example, converting the obtained information into other information, comparing the obtained information or converted information to information stored in the network node, and/or performing one or more operations based on the obtained information or converted information, and as a result of said processing making a determination.

Processing circuitry 1070 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1060 components, such as device readable medium 1080, network node 1060 functionality. For example, processing circuitry 1070 may execute instructions stored in device readable medium 1080 or in memory within processing circuitry 1070. Such functionality may include providing any of the various wireless features, functions, or benefits discussed herein. In some embodiments, processing circuitry 1070 may include a system on a chip (SOC).

In some embodiments, processing circuitry 1070 may include one or more of radio frequency (RF) transceiver circuitry 1072 and baseband processing circuitry 1074. In some embodiments, radio frequency (RF) transceiver circuitry 1072 and baseband processing circuitry 1074 may be on separate chips (or sets of chips), boards, or units, such as radio units and digital units. In alternative embodiments, part or all of RF transceiver circuitry 1072 and baseband processing circuitry 1074 may be on the same chip or set of chips, boards, or units

In certain embodiments, some or all of the functionality described herein as being provided by a network node, base station, eNB or other such network device may be performed by processing circuitry 1070 executing instructions stored on device readable medium 1080 or memory within processing circuitry 1070. In alternative embodiments, some or all of the functionality may be provided by processing circuitry 1070 without executing instructions stored on a separate or discrete device readable medium, such as in a hard-wired manner. In any of those embodiments, whether executing instructions stored on a device readable storage medium or not, processing circuitry 1070 can be configured to perform the described functionality. The benefits provided by such functionality are not limited to processing circuitry 1070 alone or to other components of network node 1060, but are enjoyed by network node 1060 as a whole, and/or by end users and the wireless network generally.

Device readable medium 1080 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1070. Device readable medium 1080 may store any suitable instructions, data or information, including a computer program, software, an application including one or more of logic, rules, code, tables, etc. and/or other instructions capable of being executed by processing circuitry 1070 and, utilized by network node 1060. Device readable medium 1080 may be used to store any calculations made by processing circuitry 1070 and/or any data received via interface 1090. In some embodiments, processing circuitry 1070 and device readable medium 1080 may be considered to be integrated.

Interface 1090 is used in the wired or wireless communication of signalling and/or data between network node 1060, network 1006, and/or WDs 1010. As illustrated, interface 1090 comprises port(s)/terminal(s) 1094 to send and receive data, for example to and from network 1006 over a wired connection. Interface 1090 also includes radio front end circuitry 1092 that may be coupled to, or in certain embodiments a part of, antenna 1062. Radio front end circuitry 1092 comprises filters 1098 and amplifiers 1096. Radio front end circuitry 1092 may be connected to antenna 1062 and processing circuitry 1070. Radio front end circuitry may be configured to condition signals communicated between antenna 1062 and processing circuitry 1070. Radio front end circuitry 1092 may receive digital data that is to be sent out to other network nodes or WDs via a wireless connection. Radio front end circuitry 1092 may convert the digital data into a radio signal having the appropriate channel and bandwidth parameters using a combination of filters 1098 and/or amplifiers 1096. The radio signal may then be transmitted via antenna 1062. Similarly, when receiving data, antenna 1062 may collect radio signals which are then converted into digital data by radio front end circuitry 1092. The digital data may be passed to processing circuitry 1070. In other embodiments, the interface may comprise different components and/or different combinations of components.

In certain alternative embodiments, network node 1060 may not include separate radio front end circuitry 1092, instead, processing circuitry 1070 may comprise radio front end circuitry and may be connected to antenna 1062 without separate radio front end circuitry 1092. Similarly, in some embodiments, all or some of RF transceiver circuitry 1072 may be considered a part of interface 1090. In still other embodiments, interface 1090 may include one or more ports or terminals 1094, radio front end circuitry 1092, and RF transceiver circuitry 1072, as part of a radio unit (not shown), and interface 1090 may communicate with baseband processing circuitry 1074, which is part of a digital unit (not shown).

Antenna 1062 may include one or more antennas, or antenna arrays, configured to send and/or receive wireless signals. Antenna 1062 may be coupled to radio front end circuitry 1090 and may be any type of antenna capable of transmitting and receiving data and/or signals wirelessly. In some embodiments, antenna 1062 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1062 may be separate from network node 1060 and may be connectable to network node 1060 through an interface or port.

Antenna 1062, interface 1090, and/or processing circuitry 1070 may be configured to perform any receiving operations and/or certain obtaining operations described herein as being performed by a network node. Any information, data and/or signals may be received from a wireless device, another network node and/or any other network equipment. Similarly, antenna 1062, interface 1090, and/or processing circuitry 1070 may be configured to perform any transmitting operations described herein as being performed by a network node. Any information, data and/or signals may be transmitted to a wireless device, another network node and/or any other network equipment.

Power circuitry 1087 may comprise, or be coupled to, power management circuitry and is configured to supply the components of network node 1060 with power for performing the functionality described herein. Power circuitry 1087 may receive power from power source 1086. Power source 1086 and/or power circuitry 1087 may be configured to provide power to the various components of network node 1060 in a form suitable for the respective components (e.g., at a voltage and current level needed for each respective component). Power source 1086 may either be included in, or external to, power circuitry 1087 and/or network node 1060. For example, network node 1060 may be connectable to an external power source (e.g., an electricity outlet) via an input circuitry or interface such as an electrical cable, whereby the external power source supplies power to power circuitry 1087. As a further example, power source 1086 may comprise a source of power in the form of a battery or battery pack which is connected to, or integrated in, power circuitry 1087. The battery may provide backup power should the external power source fail. Other types of power sources, such as photovoltaic devices, may also be used.

Alternative embodiments of network node 1060 may include additional components beyond those shown in FIG. 10 that may be responsible for providing certain aspects of the network node's functionality, including any of the functionality described herein and/or any functionality necessary to support the subject matter described herein. For example, network node 1060 may include user interface equipment to allow input of information into network node 1060 and to allow output of information from network node 1060. This may allow a user to perform diagnostic, maintenance, repair, and other administrative functions for network node 1060.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1010 includes antenna 1011, interface 1014, processing circuitry 1020, device readable medium 1030, user interface equipment 1032, auxiliary equipment 1034, power source 1036 and power circuitry 1037. WD 1010 may include multiple sets of one or more of the illustrated components for different wireless technologies supported by WD 1010, such as, for example, GSM, WCDMA, LTE, NR, WiFi, WiMAX, or Bluetooth wireless technologies, just to mention a few. These wireless technologies may be integrated into the same or different chips or set of chips as other components within WD 1010.

Antenna 1011 may include one or more antennas or antenna arrays, configured to send and/or receive wireless signals, and is connected to interface 1014. In certain alternative embodiments, antenna 1011 may be separate from WD 1010 and be connectable to WD 1010 through an interface or port. Antenna 1011, interface 1014, and/or processing circuitry 1020 may be configured to perform any receiving or transmitting operations described herein as being performed by a WD. Any information, data and/or signals may be received from a network node and/or another WD. In some embodiments, radio front end circuitry and/or antenna 1011 may be considered an interface.

As illustrated, interface 1014 comprises radio front end circuitry 1012 and antenna 1011. Radio front end circuitry 1012 comprise one or more filters 1018 and amplifiers 1016. Radio front end circuitry 1014 is connected to antenna 1011 and processing circuitry 1020, and is configured to condition signals communicated between antenna 1011 and processing circuitry 1020. Radio front end circuitry 1012 may be coupled to or a part of antenna 1011. In some embodiments, WD 1010 may not include separate radio front end circuitry 1012; rather, processing circuitry 1020 may comprise radio front end circuitry and may be connected to antenna 1011. Similarly, in some embodiments, some or all of RF transceiver circuitry 1022 may be considered a part of interface 1014. Radio front end circuitry 1012 may receive digital data that is to be sent out to other network nodes or WDs via a wireless connection. Radio front end circuitry 1012 may convert the digital data into a radio signal having the appropriate channel and bandwidth parameters using a combination of filters 1018 and/or amplifiers 1016. The radio signal may then be transmitted via antenna 1011. Similarly, when receiving data, antenna 1011 may collect radio signals which are then converted into digital data by radio front end circuitry 1012. The digital data may be passed to processing circuitry 1020. In other embodiments, the interface may comprise different components and/or different combinations of components.

Processing circuitry 1020 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1010 components, such as device readable medium 1030, WD 1010 functionality. Such functionality may include providing any of the various wireless features or benefits discussed herein. For example, processing circuitry 1020 may execute instructions stored in device readable medium 1030 or in memory within processing circuitry 1020 to provide the functionality disclosed herein.

As illustrated, processing circuitry 1020 includes one or more of RF transceiver circuitry 1022, baseband processing circuitry 1024, and application processing circuitry 1026. In other embodiments, the processing circuitry may comprise different components and/or different combinations of components. In certain embodiments processing circuitry 1020 of WD 1010 may comprise a SOC. In some embodiments, RF transceiver circuitry 1022, baseband processing circuitry 1024, and application processing circuitry 1026 may be on separate chips or sets of chips. In alternative embodiments, part or all of baseband processing circuitry 1024 and application processing circuitry 1026 may be combined into one chip or set of chips, and RF transceiver circuitry 1022 may be on a separate chip or set of chips. In still alternative embodiments, part or all of RF transceiver circuitry 1022 and baseband processing circuitry 1024 may be on the same chip or set of chips, and application processing circuitry 1026 may be on a separate chip or set of chips. In yet other alternative embodiments, part or all of RF transceiver circuitry 1022, baseband processing circuitry 1024, and application processing circuitry 1026 may be combined in the same chip or set of chips. In some embodiments, RF transceiver circuitry 1022 may be a part of interface 1014. RF transceiver circuitry 1022 may condition RF signals for processing circuitry 1020.

In certain embodiments, some or all of the functionality described herein as being performed by a WD may be provided by processing circuitry 1020 executing instructions stored on device readable medium 1030, which in certain embodiments may be a computer-readable storage medium. In alternative embodiments, some or all of the functionality may be provided by processing circuitry 1020 without executing instructions stored on a separate or discrete device readable storage medium, such as in a hard-wired manner. In any of those particular embodiments, whether executing instructions stored on a device readable storage medium or not, processing circuitry 1020 can be configured to perform the described functionality. The benefits provided by such functionality are not limited to processing circuitry 1020 alone or to other components of WD 1010, but are enjoyed by WD 1010 as a whole, and/or by end users and the wireless network generally.

Processing circuitry 1020 may be configured to perform any determining, calculating, or similar operations (e.g., certain obtaining operations) described herein as being performed by a WD. These operations, as performed by processing circuitry 1020, may include processing information obtained by processing circuitry 1020 by, for example, converting the obtained information into other information, comparing the obtained information or converted information to information stored by WD 1010, and/or performing one or more operations based on the obtained information or converted information, and as a result of said processing making a determination.

Device readable medium 1030 may be operable to store a computer program, software, an application including one or more of logic, rules, code, tables, etc. and/or other instructions capable of being executed by processing circuitry 1020. Device readable medium 1030 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1020. In some embodiments, processing circuitry 1020 and device readable medium 1030 may be considered to be integrated.

User interface equipment 1032 may provide components that allow for a human user to interact with WD 1010. Such interaction may be of many forms, such as visual, audial, tactile, etc. User interface equipment 1032 may be operable to produce output to the user and to allow the user to provide input to WD 1010. The type of interaction may vary depending on the type of user interface equipment 1032 installed in WD 1010. For example, if WD 1010 is a smart phone, the interaction may be via a touch screen; if WD 1010 is a smart meter, the interaction may be through a screen that provides usage (e.g., the number of gallons used) or a speaker that provides an audible alert (e.g., if smoke is detected). User interface equipment 1032 may include input interfaces, devices and circuits, and output interfaces, devices and circuits. User interface equipment 1032 is configured to allow input of information into WD 1010, and is connected to processing circuitry 1020 to allow processing circuitry 1020 to process the input information. User interface equipment 1032 may include, for example, a microphone, a proximity or other sensor, keys/buttons, a touch display, one or more cameras, a USB port, or other input circuitry. User interface equipment 1032 is also configured to allow output of information from WD 1010, and to allow processing circuitry 1020 to output information from WD 1010. User interface equipment 1032 may include, for example, a speaker, a display, vibrating circuitry, a USB port, a headphone interface, or other output circuitry. Using one or more input and output interfaces, devices, and circuits, of user interface equipment 1032, WD 1010 may communicate with end users and/or the wireless network, and allow them to benefit from the functionality described herein.

Auxiliary equipment 1034 is operable to provide more specific functionality which may not be generally performed by WDs. This may comprise specialized sensors for doing measurements for various purposes, interfaces for additional types of communication such as wired communications etc. The inclusion and type of components of auxiliary equipment 1034 may vary depending on the embodiment and/or scenario.

Power source 1036 may, in some embodiments, be in the form of a battery or battery pack. Other types of power sources, such as an external power source (e.g., an electricity outlet), photovoltaic devices or power cells, may also be used. WD 1010 may further comprise power circuitry 1037 for delivering power from power source 1036 to the various parts of WD 1010 which need power from power source 1036 to carry out any functionality described or indicated herein. Power circuitry 1037 may in certain embodiments comprise power management circuitry. Power circuitry 1037 may additionally or alternatively be operable to receive power from an external power source; in which case WD 1010 may be connectable to the external power source (such as an electricity outlet) via input circuitry or an interface such as an electrical power cable. Power circuitry 1037 may also in certain embodiments be operable to deliver power from an external power source to power source 1036. This may be, for example, for the charging of power source 1036. Power circuitry 1037 may perform any formatting, converting, or other modification to the power from power source 1036 to make the power suitable for the respective components of WD 1010 to which power is supplied.

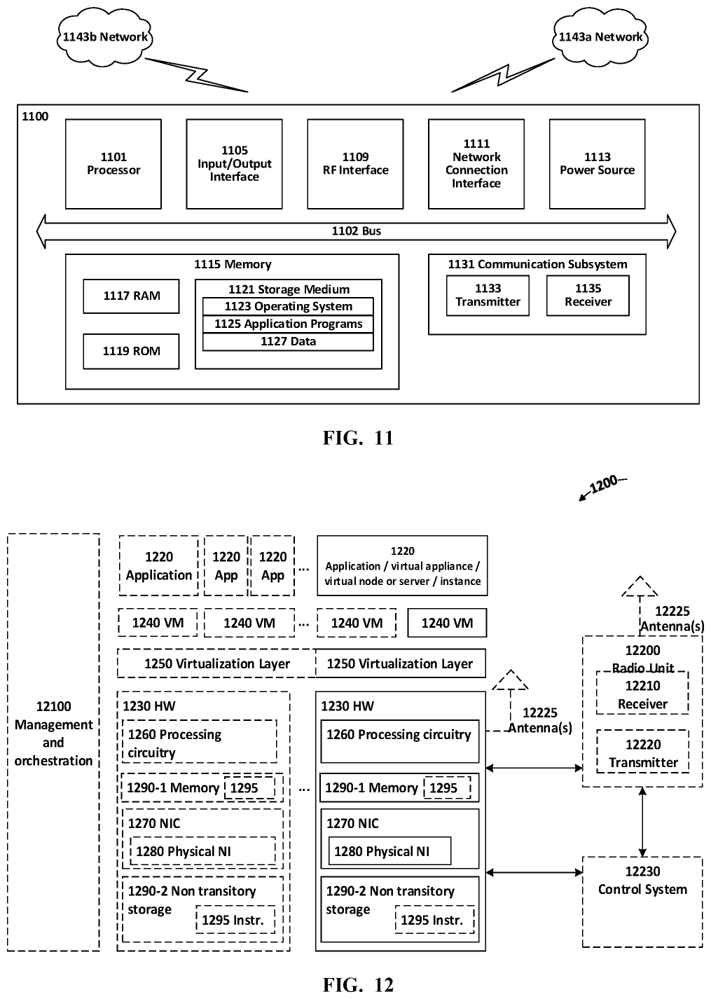

FIG. 11 is a schematic showing a user equipment in accordance with some embodiments.

FIG. 11 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1100 may be any UE identified by the 3rd Generation Partnership Project (3GPP), including a NB-IoT UE, a machine type communication (MTC) UE, and/or an enhanced MTC (eMTC) UE. UE 1100, as illustrated in FIG. 11, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 11 is a UE, the components discussed herein are equally applicable to a WD, and vice-versa.

In FIG. 11, UE 1100 includes processing circuitry 1101 that is operatively coupled to input/output interface 1105, radio frequency (RF) interface 1109, network connection interface 1111, memory 1115 including random access memory (RAM) 1117, read-only memory (ROM) 1119, and storage medium 1121 or the like, communication subsystem 1131, power source 1133, and/or any other component, or any combination thereof. Storage medium 1121 includes operating system 1123, application program 1125, and data 1127. In other embodiments, storage medium 1121 may include other similar types of information. Certain UEs may utilize all of the components shown in FIG. 11, or only a subset of the components. The level of integration between the components may vary from one UE to another UE. Further, certain UEs may contain multiple instances of a component, such as multiple processors, memories, transceivers, transmitters, receivers, etc.

In FIG. 11, processing circuitry 1101 may be configured to process computer instructions and data. Processing circuitry 1101 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1101 may include two central processing units (CPUs). Data may be information in a form suitable for use by a computer.

In the depicted embodiment, input/output interface 1105 may be configured to provide a communication interface to an input device, output device, or input and output device. UE 1100 may be configured to use an output device via input/output interface 1105. An output device may use the same type of interface port as an input device. For example, a USB port may be used to provide input to and output from UE 1100. The output device may be a speaker, a sound card, a video card, a display, a monitor, a printer, an actuator, an emitter, a smartcard, another output device, or any combination thereof. UE 1100 may be configured to use an input device via input/output interface 1105 to allow a user to capture information into UE 1100. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 11, RF interface 1109 may be configured to provide a communication interface to RF components such as a transmitter, a receiver, and an antenna. Network connection interface 1111 may be configured to provide a communication interface to network 1143a. Network 1143a may encompass wired and/or wireless networks such as a local-area network (LAN), a wide-area network (WAN), a computer network, a wireless network, a telecommunications network, another like network or any combination thereof. For example, network 1143a may comprise a Wi-Fi network. Network connection interface 1111 may be configured to include a receiver and a transmitter interface used to communicate with one or more other devices over a communication network according to one or more communication protocols, such as Ethernet, TCP/IP, SONET, ATM, or the like. Network connection interface 1111 may implement receiver and transmitter functionality appropriate to the communication network links (e.g., optical, electrical, and the like). The transmitter and receiver functions may share circuit components, software or firmware, or alternatively may be implemented separately.

RAM 1117 may be configured to interface via bus 1102 to processing circuitry 1101 to provide storage or caching of data or computer instructions during the execution of software programs such as the operating system, application programs, and device drivers. ROM 1119 may be configured to provide computer instructions or data to processing circuitry 1101. For example, ROM 1119 may be configured to store invariant low-level system code or data for basic system functions such as basic input and output (I/O), startup, or reception of keystrokes from a keyboard that are stored in a non-volatile memory. Storage medium 1121 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1121 may be configured to include operating system 1123, application program 1125 such as a web browser application, a widget or gadget engine or another application, and data file 1127. Storage medium 1121 may store, for use by UE 1100, any of a variety of various operating systems or combinations of operating systems.

Storage medium 1121 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1121 may allow UE 1100 to access computer-executable instructions, application programs or the like, stored on transitory or non-transitory memory media, to off-load data, or to upload data. An article of manufacture, such as one utilizing a communication system may be tangibly embodied in storage medium 1121, which may comprise a device readable medium.

In FIG. 11, processing circuitry 1101 may be configured to communicate with network 1143b using communication subsystem 1131. Network 1143a and network 1143b may be the same network or networks or different network or networks. Communication subsystem 1131 may be configured to include one or more transceivers used to communicate with network 1143b. For example, communication subsystem 1131 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 1133 and/or receiver 1135 to implement transmitter or receiver functionality, respectively, appropriate to the RAN links (e.g., frequency allocations and the like). Further, transmitter 1133 and receiver 1135 of each transceiver may share circuit components, software or firmware, or alternatively may be implemented separately.

In the illustrated embodiment, the communication functions of communication subsystem 1131 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1131 may include cellular communication, Wi-Fi communication, Bluetooth communication, and GPS communication. Network 1143b may encompass wired and/or wireless networks such as a local-area network (LAN), a wide-area network (WAN), a computer network, a wireless network, a telecommunications network, another like network or any combination thereof. For example, network 1143b may be a cellular network, a Wi-Fi network, and/or a near-field network. Power source 1113 may be configured to provide alternating current (AC) or direct current (DC) power to components of UE 1100.

The features, benefits and/or functions described herein may be implemented in one of the components of UE 1100 or partitioned across multiple components of UE 1100. Further, the features, benefits, and/or functions described herein may be implemented in any combination of hardware, software or firmware. In one example, communication subsystem 1131 may be configured to include any of the components described herein. Further, processing circuitry 1101 may be configured to communicate with any of such components over bus 1102. In another example, any of such components may be represented by program instructions stored in memory that when executed by processing circuitry 1101 perform the corresponding functions described herein. In another example, the functionality of any of such components may be partitioned between processing circuitry 1101 and communication subsystem 1131. In another example, the non-computationally intensive functions of any of such components may be implemented in software or firmware and the computationally intensive functions may be implemented in hardware.

FIG. 12 is a schematic showing a virtualization environment in accordance with some embodiments.

FIG. 12 is a schematic block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1200 hosted by one or more of hardware nodes 1230. Further, in embodiments in which the virtual node is not a radio access node or does not require radio connectivity (e.g., a core network node), then the network node may be entirely virtualized.

The functions may be implemented by one or more applications 1220 (which may alternatively be called software instances, virtual appliances, network functions, virtual nodes, virtual network functions, etc.) operative to implement some of the features, functions, and/or benefits of some of the embodiments disclosed herein. Applications 1220 are run in virtualization environment 1200 which provides hardware 1230 comprising processing circuitry 1260 and memory 1290. Memory 1290 contains instructions 1295 executable by processing circuitry 1260 whereby application 1220 is operative to provide one or more of the features, benefits, and/or functions disclosed herein.

Virtualization environment 1200, comprises general-purpose or special-purpose network hardware devices 1230 comprising a set of one or more processors or processing circuitry 1260, which may be commercial off-the-shelf (COTS) processors, dedicated Application Specific Integrated Circuits (ASICs), or any other type of processing circuitry including digital or analog hardware components or special purpose processors. Each hardware device may comprise memory 1290-1 which may be non-persistent memory for temporarily storing instructions 1295 or software executed by processing circuitry 1260. Each hardware device may comprise one or more network interface controllers (NICs) 1270, also known as network interface cards, which include physical network interface 1280. Each hardware device may also include non-transitory, persistent, machine-readable storage media 1290-2 having stored therein software 1295 and/or instructions executable by processing circuitry 1260. Software 1295 may include any type of software including software for instantiating one or more virtualization layers 1250 (also referred to as hypervisors), software to execute virtual machines 1240 as well as software allowing it to execute functions, features and/or benefits described in relation with some embodiments described herein.

Virtual machines 1240, comprise virtual processing, virtual memory, virtual networking or interface and virtual storage, and may be run by a corresponding virtualization layer 1250 or hypervisor. Different embodiments of the instance of virtual appliance 1220 may be implemented on one or more of virtual machines 1240, and the implementations may be made in different ways.

During operation, processing circuitry 1260 executes software 1295 to instantiate the hypervisor or virtualization layer 1250, which may sometimes be referred to as a virtual machine monitor (VMM). Virtualization layer 1250 may present a virtual operating platform that appears like networking hardware to virtual machine 1240.

As shown in FIG. 12, hardware 1230 may be a standalone network node with generic or specific components. Hardware 1230 may comprise antenna 12225 and may implement some functions via virtualization. Alternatively, hardware 1230 may be part of a larger cluster of hardware (e.g. such as in a data center or customer premise equipment (CPE)) where many hardware nodes work together and are managed via management and orchestration (MANO) 12100, which, among others, oversees lifecycle management of applications 1220.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1240 may be a software implementation of a physical machine that runs programs as if they were executing on a physical, non-virtualized machine. Each of virtual machines 1240, and that part of hardware 1230 that executes that virtual machine, be it hardware dedicated to that virtual machine and/or hardware shared by that virtual machine with others of the virtual machines 1240, forms a separate virtual network elements (VNE).

Still in the context of NFV, Virtual Network Function (VNF) is responsible for handling specific network functions that run in one or more virtual machines 1240 on top of hardware networking infrastructure 1230 and corresponds to application 1220 in FIG. 12.

In some embodiments, one or more radio units 12200 that each include one or more transmitters 12220 and one or more receivers 12210 may be coupled to one or more antennas 12225. Radio units 12200 may communicate directly with hardware nodes 1230 via one or more appropriate network interfaces and may be used in combination with the virtual components to provide a virtual node with radio capabilities, such as a radio access node or a base station.

In some embodiments, some signalling can be effected with the use of control system 12230 which may alternatively be used for communication between the hardware nodes 1230 and radio units 12200.

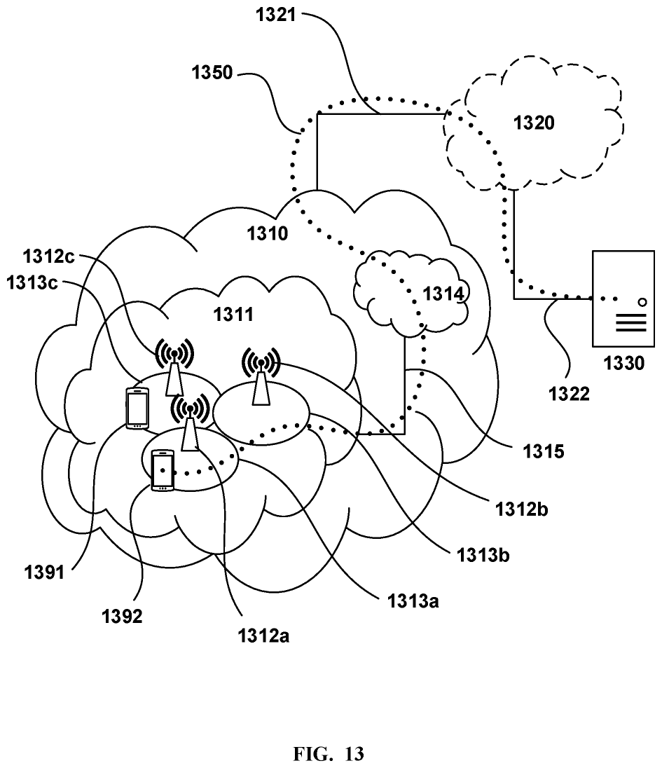

FIG. 13 is a schematic showing a telecommunication network connected via an intermediate network to a host computer in accordance with some embodiments.

With reference to FIG. 13, in accordance with an embodiment, a communication system includes telecommunication network 1310, such as a 3GPP-type cellular network, which comprises access network 1311, such as a radio access network, and core network 1314. Access network 1311 comprises a plurality of base stations 1312a, 1312b, 1312c, such as NBs, eNBs, gNBs or other types of wireless access points, each defining a corresponding coverage area 1313a, 1313b, 1313c. Each base station 1312a, 1312b, 1312c is connectable to core network 1314 over a wired or wireless connection 1315. A first UE 1391 located in coverage area 1313c is configured to wirelessly connect to, or be paged by, the corresponding base station 1312c. A second UE 1392 in coverage area 1313a is wirelessly connectable to the corresponding base station 1312a. While a plurality of UEs 1391, 1392 are illustrated in this example, the disclosed embodiments are equally applicable to a situation where a sole UE is in the coverage area or where a sole UE is connecting to the corresponding base station 1312.

Telecommunication network 1310 is itself connected to host computer 1330, which may be embodied in the hardware and/or software of a standalone server, a cloud-implemented server, a distributed server or as processing resources in a server farm. Host computer 1330 may be under the ownership or control of a service provider, or may be operated by the service provider or on behalf of the service provider. Connections 1321 and 1322 between telecommunication network 1310 and host computer 1330 may extend directly from core network 1314 to host computer 1330 or may go via an optional intermediate network 1320. Intermediate network 1320 may be one of, or a combination of more than one of, a public, private or hosted network; intermediate network 1320, if any, may be a backbone network or the Internet; in particular, intermediate network 1320 may comprise two or more sub-networks (not shown).

The communication system of FIG. 13 as a whole enables connectivity between the connected UEs 1391, 1392 and host computer 1330. The connectivity may be described as an over-the-top (OTT) connection 1350. Host computer 1330 and the connected UEs 1391, 1392 are configured to communicate data and/or signaling via OTT connection 1350, using access network 1311, core network 1314, any intermediate network 1320 and possible further infrastructure (not shown) as intermediaries. OTT connection 1350 may be transparent in the sense that the participating communication devices through which OTT connection 1350 passes are unaware of routing of uplink and downlink communications. For example, base station 1312 may not or need not be informed about the past routing of an incoming downlink communication with data originating from host computer 1330 to be forwarded (e.g., handed over) to a connected UE 1391. Similarly, base station 1312 need not be aware of the future routing of an outgoing uplink communication originating from the UE 1391 towards the host computer 1330.

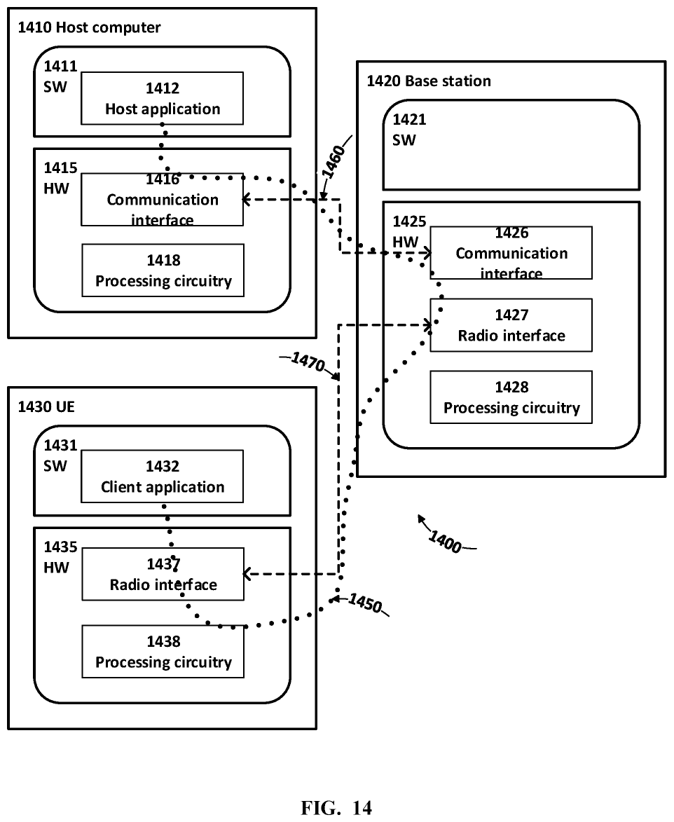

FIG. 14 is a schematic showing a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 14. In communication system 1400, host computer 1410 comprises hardware 1415 including communication interface 1416 configured to set up and maintain a wired or wireless connection with an interface of a different communication device of communication system 1400. Host computer 1410 further comprises processing circuitry 1418, which may have storage and/or processing capabilities. In particular, processing circuitry 1418 may comprise one or more programmable processors, application-specific integrated circuits, field programmable gate arrays or combinations of these (not shown) adapted to execute instructions. Host computer 1410 further comprises software 1411, which is stored in or accessible by host computer 1410 and executable by processing circuitry 1418. Software 1411 includes host application 1412. Host application 1412 may be operable to provide a service to a remote user, such as UE 1430 connecting via OTT connection 1450 terminating at UE 1430 and host computer 1410. In providing the service to the remote user, host application 1412 may provide user data which is transmitted using OTT connection 1450.

Communication system 1400 further includes base station 1420 provided in a telecommunication system and comprising hardware 1425 enabling it to communicate with host computer 1410 and with UE 1430. Hardware 1425 may include communication interface 1426 for setting up and maintaining a wired or wireless connection with an interface of a different communication device of communication system 1400, as well as radio interface 1427 for setting up and maintaining at least wireless connection 1470 with UE 1430 located in a coverage area (not shown in FIG. 14) served by base station 1420. Communication interface 1426 may be configured to facilitate connection 1460 to host computer 1410. Connection 1460 may be direct or it may pass through a core network (not shown in FIG. 14) of the telecommunication system and/or through one or more intermediate networks outside the telecommunication system. In the embodiment shown, hardware 1425 of base station 1420 further includes processing circuitry 1428, which may comprise one or more programmable processors, application-specific integrated circuits, field programmable gate arrays or combinations of these (not shown) adapted to execute instructions. Base station 1420 further has software 1421 stored internally or accessible via an external connection.

Communication system 1400 further includes UE 1430 already referred to. Its hardware 1435 may include radio interface 1437 configured to set up and maintain wireless connection 1470 with a base station serving a coverage area in which UE 1430 is currently located. Hardware 1435 of UE 1430 further includes processing circuitry 1438, which may comprise one or more programmable processors, application-specific integrated circuits, field programmable gate arrays or combinations of these (not shown) adapted to execute instructions. UE 1430 further comprises software 1431, which is stored in or accessible by UE 1430 and executable by processing circuitry 1438. Software 1431 includes client application 1432. Client application 1432 may be operable to provide a service to a human or non-human user via UE 1430, with the support of host computer 1410. In host computer 1410, an executing host application 1412 may communicate with the executing client application 1432 via OTT connection 1450 terminating at UE 1430 and host computer 1410. In providing the service to the user, client application 1432 may receive request data from host application 1412 and provide user data in response to the request data. OTT connection 1450 may transfer both the request data and the user data. Client application 1432 may interact with the user to generate the user data that it provides.

It is noted that host computer 1410, base station 1420 and UE 1430 illustrated in FIG. 14 may be similar or identical to host computer 1330, one of base stations 1312a, 1312b, 1312c and one of UEs 1391, 1392 of FIG. 13, respectively. This is to say, the inner workings of these entities may be as shown in FIG. 14 and independently, the surrounding network topology may be that of FIG. 13.

In FIG. 14, OTT connection 1450 has been drawn abstractly to illustrate the communication between host computer 1410 and UE 1430 via base station 1420, without explicit reference to any intermediary devices and the precise routing of messages via these devices. Network infrastructure may determine the routing, which it may be configured to hide from UE 1430 or from the service provider operating host computer 1410, or both. While OTT connection 1450 is active, the network infrastructure may further take decisions by which it dynamically changes the routing (e.g., on the basis of load balancing consideration or reconfiguration of the network).

Wireless connection 1470 between UE 1430 and base station 1420 is in accordance with the teachings of the embodiments described throughout this disclosure. One or more of the various embodiments improve the performance of OTT services provided to UE 1430 using OTT connection 1450, in which wireless connection 1470 forms the last segment. More precisely, the teachings of these embodiments may improve the latency, and power consumption for a reactivation of the network connection, and thereby provide benefits, such as reduced user waiting time, enhanced rate control.

A measurement procedure may be provided for the purpose of monitoring data rate, latency and other factors on which the one or more embodiments improve. There may further be an optional network functionality for reconfiguring OTT connection 1450 between host computer 1410 and UE 1430, in response to variations in the measurement results. The measurement procedure and/or the network functionality for reconfiguring OTT connection 1450 may be implemented in software 1411 and hardware 1415 of host computer 1410 or in software 1431 and hardware 1435 of UE 1430, or both. In embodiments, sensors (not shown) may be deployed in or in association with communication devices through which OTT connection 1450 passes; the sensors may participate in the measurement procedure by supplying values of the monitored quantities exemplified above, or supplying values of other physical quantities from which software 1411, 1431 may compute or estimate the monitored quantities. The reconfiguring of OTT connection 1450 may include message format, retransmission settings, preferred routing etc.; the reconfiguring need not affect base station 1420, and it may be unknown or imperceptible to base station 1420. Such procedures and functionalities may be known and practiced in the art. In certain embodiments, measurements may involve proprietary UE signaling facilitating host computer 1410's measurements of throughput, propagation times, latency and the like. The measurements may be implemented in that software 1411 and 1431 causes messages to be transmitted, in particular empty or ‘dummy’ messages, using OTT connection 1450 while it monitors propagation times, errors etc.

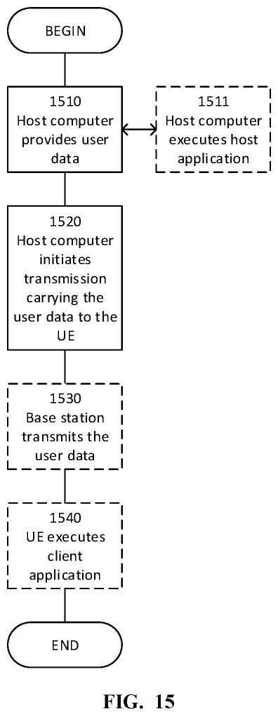

FIG. 15 is a schematic showing methods implemented in a communication system including a host computer, a base station and a user equipment in accordance with some embodiments.

The communication system includes a host computer, a base station and a UE which may be those described with reference to FIGS. 13 and 14. For simplicity of the present disclosure, only drawing references to FIG. 15 will be included in this section. In step 1510, the host computer provides user data. In substep 1511 (which may be optional) of step 1510, the host computer provides the user data by executing a host application. In step 1520, the host computer initiates a transmission carrying the user data to the UE. In step 1530 (which may be optional), the base station transmits to the UE the user data which was carried in the transmission that the host computer initiated, in accordance with the teachings of the embodiments described throughout this disclosure. In step 1540 (which may also be optional), the UE executes a client application associated with the host application executed by the host computer.

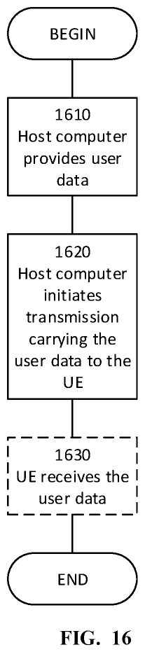

FIG. 16 is a schematic showing methods implemented in a communication system including a host computer, a base station and a user equipment in accordance with some embodiments.

The communication system includes a host computer, a base station and a UE which may be those described with reference to FIGS. 13 and 14. For simplicity of the present disclosure, only drawing references to FIG. 16 will be included in this section. In step 1610 of the method, the host computer provides user data. In an optional substep (not shown) the host computer provides the user data by executing a host application. In step 1620, the host computer initiates a transmission carrying the user data to the UE. The transmission may pass via the base station, in accordance with the teachings of the embodiments described throughout this disclosure. In step 1630 (which may be optional), the UE receives the user data carried in the transmission.

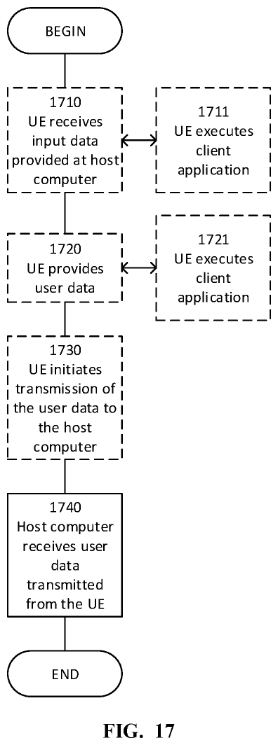

FIG. 17 is a schematic showing methods implemented in a communication system including a host computer, a base station and a user equipment in accordance with some embodiments.

The communication system includes a host computer, a base station and a UE which may be those described with reference to FIGS. 13 and 14. For simplicity of the present disclosure, only drawing references to FIG. 17 will be included in this section. In step 1710 (which may be optional), the UE receives input data provided by the host computer. Additionally or alternatively, in step 1720, the UE provides user data. In substep 1721 (which may be optional) of step 1720, the UE provides the user data by executing a client application. In substep 1711 (which may be optional) of step 1710, the UE executes a client application which provides the user data in reaction to the received input data provided by the host computer. In providing the user data, the executed client application may further consider user input received from the user. Regardless of the specific manner in which the user data was provided, the UE initiates, in substep 1730 (which may be optional), transmission of the user data to the host computer. In step 1740 of the method, the host computer receives the user data transmitted from the UE, in accordance with the teachings of the embodiments described throughout this disclosure.

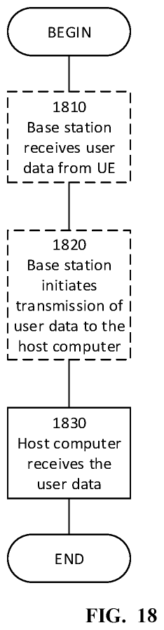

FIG. 18 is a schematic showing methods implemented in a communication system including a host computer, a base station and a user equipment in accordance with some embodiments.

The communication system includes a host computer, a base station and a UE which may be those described with reference to FIGS. 13 and 14. For simplicity of the present disclosure, only drawing references to FIG. 18 will be included in this section. In step 1810 (which may be optional), in accordance with the teachings of the embodiments described throughout this disclosure, the base station receives user data from the UE. In step 1820 (which may be optional), the base station initiates transmission of the received user data to the host computer. In step 1830 (which may be optional), the host computer receives the user data carried in the transmission initiated by the base station.

In general, the various exemplary embodiments of the present disclosure may be implemented in hardware or special purpose circuits, software, logic or any combination thereof. For example, some aspects may be implemented in hardware, while other aspects may be implemented in firmware or software that may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may include circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by those skilled in the art, the functionality of the program modules may be combined or distributed as desired in various embodiments. In addition, the functionality may be embodied in whole or in part in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

| Abbreviation | Explanation |
|---|---|
| CRS | Cell Specific Reference Signals |
| LTE | Long Term Evolution |
| NB-IoT | Narrowband Internet of Things |
| NPBCH | Narrowband Physical Broadcast Channel |
| NPDCCH | Narrowband Physical Downlink Control Channel |
| NPDSCH | Narrowband Physical Downlink Shared Channel |
| NPRACH | Narrowband Physical Random Access Channel |
| NPSS | Narrowband Primary Synchronization Sequence |
| NRS | Narrowband Reference Signals |
| NSSS | Narrowband Secondary Synchronization Sequence |
| SNR | Signal to noise ratio |

1.-55. (canceled)

56. A method performed at a terminal device, the method comprising:
determining whether a first condition or a second condition is met, based on a communication quality; and
performing a measurement associated to a resource, when the first condition is met, or stopping the measurement associated to the resource, when the second condition is met, wherein the communication quality comprises narrow band reference signal received power (NRSRP), wherein the first condition comprises that a first event is triggered, and the first event is triggered when the communication quality is equal to or lower than a first threshold, wherein the second condition comprises that the second event is triggered and at least a second period has elapsed since the triggering of the second event, and the second event is trigged when the communication quality is equal to or higher than a second threshold, wherein a second timer and/or a second counter is started upon the triggering of the second event, and the second period has elapsed when the second timer expires and/or when the second counter reaches a set value, wherein the terminal device comprises a narrow band internet of things (NB-IoT) device.

57. The method according to claim 56, wherein the resource comprises at least one carrier frequency and/or at least one cell.

58. The method according to claim 56, further comprising obtaining a configuration for assisting the terminal device to perform a measurement associated to a resource.

59. The method according to claim 58, wherein the configuration comprises at least one of:
at least one identifier of the at least one carrier frequency;
at least one identifier of the at least one cell;
a type of the measurement;
a source cell reference signal received power, RSRP, threshold for initiating a reestablishment procedure;
a source cell reference signal received quality, RSRQ, threshold for initiating a reestablishment procedure;
a target cell RSRP threshold;
a target cell RSRQ threshold; or
system information of the at least one cell.

60. The method according to claim 58, wherein the configuration comprises at least one parameter associated to the first condition, and wherein the at least one parameter includes at least one of:
an operation mode;
a coverage level; and
a network capacity.

61. The method according to claim 56, further comprising:
determining the communication quality of a serving cell for the terminal device;
wherein the communication quality of the serving cell is determined by measuring a reference signal including at least one of:
a narrowband reference signal, NRS;
a narrowband secondary synchronization signal, NSSS; and
a narrowband physical broadcast channel, NPBCH.

62. The method according to claim 61, wherein a first timer and/or a first counter is started upon the triggering of the first event, and wherein the first period has elapsed when the first timer expires and/or when the first counter reaches a set value.

63. The method according to claim 56, wherein the first event is cancelled when a second event is triggered.

64. The method according to claim 63, wherein the first threshold is equal to or higher than a value indicating that the terminal device is out of synchronization, and/or wherein the second threshold is equal to or higher than a value indicating that the terminal device is in synchronization.

65. The method according to claim 56, further comprising:
performing a cell change procedure, based on at least a result of the measurement; and
wherein the cell change procedure includes at least one of:
a radio resource control, RRC, re-establishment;
an RRC release with redirection; and
a handover.

66. The method according to claim 56, further comprising transmitting, to a network node, a first report about that the measurement is performed.

67. The method according to claim 66, wherein the first report further comprises information about at least of:
a cell, on which the measurement is performed; and
a triggering condition for performing the measurement; and/or
wherein the first report further comprises information about whether the terminal device is stationary or mobile.

68. The method according to claim 56, wherein a second timer and/or a second counter is started upon the triggering of the second event, and wherein the second period has elapsed when the second timer expires and/or when the second counter reaches a set value.

69. The method according to claim 56, wherein the terminal device stops an ongoing measurement being performed or to be performed, when a second condition is met and/or wherein the terminal device stops the ongoing measurement after an ongoing measurement activity is completed.

70. The method according to claim 56, further comprising transmitting, to a network node, a second report about that the ongoing measurement is stopped.

71. The method according to claim 70,
wherein the second report further comprises information about at least one of:
a cell, to which the ongoing measurement is associated; and
a triggering condition for stopping the ongoing measurement; and/or
wherein the second report further comprises information about whether the terminal device is stationary or mobile.

72. The method according to claim 56,
wherein whether the terminal device is stationary or mobile is indicated by a communication pattern parameter.

73. The method according to claim 56,
wherein the measurement is performed if the terminal device is mobile, and
wherein a maximum repetition number (Rmax) of the terminal device is prolonged, if the terminal device is stationary.

74. A method performed at a network node, comprising:
transmitting, to a terminal device, a configuration for assisting the terminal device to perform a measurement associated to a resource, based on a communication quality;
wherein the measurement associated to a resource is performed when a first condition is met, or stopped when a second condition is met,
wherein the communication quality comprises narrow band reference signal received power (NRSRP),
wherein the first condition comprises that a first event is triggered, and the first event is triggered when the communication quality is equal to or lower than a first threshold,
wherein the second condition comprises that the second event is triggered and at least a second period has elapsed since the triggering of the second event, and the second event is trigged when the communication quality is equal to or higher than a second threshold,
wherein a second timer and/or a second counter is started upon the triggering of the second event, and the second period has elapsed when the second timer expires and/or when the second counter reaches a set value,
wherein the terminal device comprises a narrow band internet of things (NB-IoT) device.

75. A terminal device, the terminal device comprising:
a processor; and
a memory, the memory containing instructions executable by the processor, whereby the terminal device is operative to:
determine whether a first condition or a second condition is met, based on a communication quality; and
perform a measurement associated to the resource, when the first condition is met, or stop the measurement associated to the resource, when the second condition is met,
wherein the communication quality comprises narrow band reference signal received power (NRSRP),
wherein the first condition comprises that a first event is triggered, and the first event is triggered when the communication quality is equal to or lower than a first threshold,
wherein the second condition comprises that the second event is triggered and at least a second period has elapsed since the triggering of the second event, and the second event is trigged when the communication quality is equal to or higher than a second threshold,
wherein a second timer and/or a second counter is started upon the triggering of the second event, and the second period has elapsed when the second timer expires and/or when the second counter reaches a set value,
wherein the terminal device comprises a narrow band internet of things (NB-IoT) device.
